(19) United States
(12) Patent Application Publication
(10) Pub. No.: US 2023/0261894 A1
(43) Pub. Date: Aug. 17, 2023

(54) MEETING SESSION CONTROL BASED ON ATTENTION DETERMINATION

(71) Applicant: SONY GROUP CORPORATION, Tokyo (JP)

(72) Inventors: ANUBHAV SRIVASTAVA, BANGALORE (IN); SAMYUKTA SHETTY, BANGALORE (IN); GOPINATH RAMANANDA, BANGALORE (IN); MEGHA TIWARI, BANGALORE (IN)

(21) Appl. No.: 17/671,495

(22) Filed: Feb. 14, 2022

(51) Int. Cl. H04L 12/18; G06V 40/20; G06V 40/18

(52) U.S. Cl. CPC H04L 12/1831; H04L 12/1822; G06V 40/20; G06V 40/18

(57) ABSTRACT

A system and method for meeting session control based on attention determination is provided. The system receives a plurality of images of a plurality of attendees related to a plurality of meeting sessions. The system detects one or more activities performed by each of the plurality of attendees during the corresponding meeting sessions over a period of time. The system calculates an attention score for each of the plurality of attendees for the corresponding period of time based on the detected one or more activities related to the corresponding attendee. The attention score indicates a level of attention of each attendee in the corresponding meeting sessions. The system further trains a machine learning (ML) model for each of the plurality of attendees based on the calculated attention score for each of the plurality of attendees and on the meeting categories of the corresponding meeting sessions.

### REFERENCE

None.

### FIELD

Various embodiments of the disclosure relate to meeting sessions. More specifically, various embodiments of the disclosure relate to a system and a method for meeting session control based on attention determination.

### BACKGROUND

Advancements in the field of machine learning have resulted in several applications in various spheres of life. With the outbreak of certain pandemic, almost all educational institutes, offices, meeting spaces have been shut down or significantly impacted. Therefore, several students and/or employees are obligated to learn and/or attend meetings remotely over the internet. However, remote learning and remote meeting may have different challenges, such as (but not limited to) maintaining a level of attention of each student or employee may be difficult. Certain solutions mainly focus on the content delivery, rather than on the attentiveness of participants. Therefore, there is a need for an impactful & interactive system which may consider attentiveness of attendees present in a meeting session and further improve the overall learning process for the attendees.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

A system and a method for meeting session control based on attention determination is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for meeting session control based on attention determination, in accordance with an embodiment of the disclosure.

FIG. 2 is a block diagram that illustrates an exemplary system for meeting session control based on attention determination, in accordance with an embodiment of the disclosure.

FIG. 3 is diagram that illustrates exemplary operations for training a ML model for each of a plurality of attendees related to a plurality of meeting sessions, in accordance with an embodiment of the disclosure.

FIG. 4 is diagram that illustrates exemplary operations for meeting session control based on attention determination and application of the ML model trained in FIG. 3 for a particular attendee, in accordance with an embodiment of the disclosure.

FIG. 5 is a diagram that illustrates an exemplary scenario for generation of a simulated view for the plurality of attendees related to a meeting session, in accordance with an embodiment of the disclosure.

FIG. 6 is a diagram that illustrates an exemplary user interface for rendering of dashboard information, in accordance with an embodiment of the disclosure.

FIG. 7 is a flowchart that illustrates exemplary operations for training a ML model for meeting session control based on attention determination, in accordance with an embodiment of the disclosure.

FIG. 8 is a flowchart that illustrates exemplary operations for meeting session control based on attention determination and application of the ML model for a particular attendee, in accordance with an embodiment of the disclosure.

### DETAILED DESCRIPTION

The following described implementations may be found in a disclosed system and method for meeting session control based on attention determination. Such method, when executed on the system may be configured to train a machine learning (ML) model for an attendee (such as a student or an employee) based on attention levels of the attendee determined in different meeting sessions (such as classrooms or meetings either in an offline or in online mode). The system may also generate one or more recommendations in real-time to increase the attention level of the attendee based on the application of the trained ML model associated with the corresponding attendee. To train the ML model, the system may receive a plurality of images of a plurality of attendees related to a plurality of meeting sessions. The plurality of images may be received from different imaging devices (like cameras) positioned during the meeting sessions. A meeting category for one or more meeting sessions of the plurality of meeting sessions may be different. The meeting category may be, for example, a type of meeting (i.e. classroom/offline based or online-based), a number of attendees in a meeting session, a duration of the meeting session, an average age of the attendees, a topic of the meeting session, content presented during the meeting session, or an experience of an educator of the meeting session. The system may further detect one or more activities (for example, raising hand, reading, writing, typing, talking, standing, asking/answering questions, etc) performed by each of the plurality of attendees during the corresponding meeting sessions based on the received plurality of images. The one or more activities may be detected over a period of time (for example, for a certain number of minutes/hours in a particular meeting session). The system may further calculate attention scores for each of the plurality of attendees for the corresponding period of time based on the detected one or more activities related to the corresponding attendee. The attention scores may indicate a level of attention of each attendee in the corresponding meeting sessions. The system may be further configured to train the machine learning (ML) model for each of the plurality of attendees based on the calculated attention scores for each of the plurality of attendees and based on the meeting categories of the corresponding meeting sessions. The disclosed system may be able to train a plurality of ML models for the plurality of attendees as per the attention scores calculated for the corresponding meeting sessions of different meeting categories. Thus, the disclosed system may be configured to generate and train a personalized machine learning (ML) model for each attendee. The disclosed system may train the ML model based on attention levels (i.e. calculated based on one or more activities performed by the attendee) determined during the plurality of meeting sessions of same or different meeting categories. Also, the generated ML model may be further trained based on a plurality of other factors such as facial expression of the attendee, experience information associated with the educator, environmental information (like lighting condition in meeting session), preferences/interests of the attendees, and the like in different meeting sessions. Thus, the personalized ML model may be trained for a particular attendee based on the attention scores calculated (or tracked) for the attendee for different meeting sessions with different meeting categories and with different other factors related to the meeting sessions. In other words, the trained ML model for the attendee may indicate historical data and variations/patterns related to the attention scores which may be determined for the attendee for past meeting sessions of different categories and with other factors related to the meeting sessions. Hence, the disclosed system may propose a distinctive learning model for each student (i.e., an attendee) by processing all historical data (related to the attention scores) generated from series of classroom activities over a period of time. This data may be useful for performing cumulative analysis for each student and therefore may be capable of identify strengths and weaknesses of each student. The disclosed system may further consider student's inclination towards some subjects and responsivity to teaching methods.

Based on the generation of the ML model, the disclosed system may further apply the trained ML model on images of the attendee or on calculated attention score (i.e. related to current or real-time meeting session) to further output or control a set of recommendations either for the attendee, for the educator or for content presented in the meeting session. The one or more recommendations, when followed, may increase the attention level of the attendee for the present or upcoming meeting sessions. Based on the real-time analysis of the attention levels and the output recommendations, the corresponding meeting session may be controlled to increase the attention level of the attendees.

The disclosed system may be an artificial intelligence (AI) based intelligent system that may aim to engage students (i.e. attendees) in a learning process (without interfering with the essence of normal classroom) by enabling effective delivery/impartment of knowledge by the educator of the meeting session to the plurality of attendees. The disclosed system may also be implemented as a smart classroom setup that may aim to monitor (using camera and depth sensors) attention level of each attendee and further improve overall learning process in real time based on the monitored attention level of each attendee and further based on the output recommendations for the attendee, for the educator, or for the presented content. Also, the disclosed system may utilize cumulative data (i.e. ML model trained based on the determined attention scores for different meeting sessions) to assess quality of lectures and instructors of the meeting sessions with real-time analysis of the attention levels of the attendees. Further, the disclosed system may provide a detailed time-varied individual report for each attendee in-addition to a cumulative group analysis. Therefore, the disclosed system may focus on each individual attendee to improve the learning process for each attendee. Moreover, the disclosed system may generate various reports and statistics based on several parameters like subjects, grades, (and the like) to provide a comparative analysis of each attendee with other attendees present in the meeting session. Moreover, the disclosed system may be also capable to detect malpractices (like cheating during an examination) that may be done by the attendees or the educator during the meeting session. Also, the disclosed system may have a prediction mechanism that may be tailored to study pattern of each student.

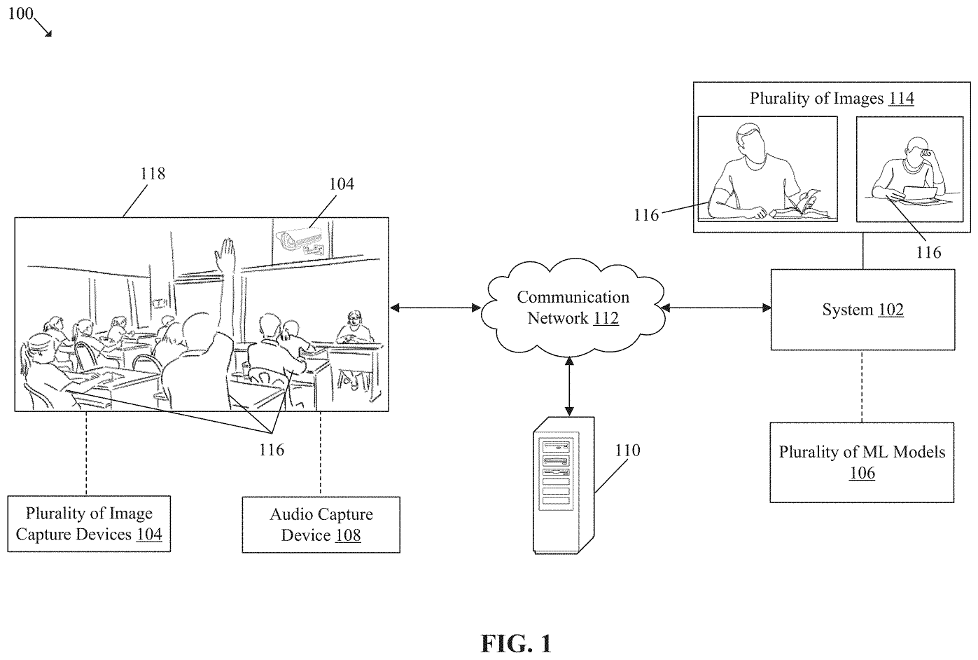

FIG. 1 is a block diagram that illustrates an exemplary network environment for meeting session control based on attention determination, in accordance with an embodiment of the disclosure. With reference to FIG. 1, there is shown a network environment 100. The network environment 100 may include a system 102, a plurality of image capture devices 104, a plurality of machine learning (ML) models 106, an audio capture device 108, a server 110, and a communication network 112. With reference to FIG. 1, there is further shown a plurality of images 114 of a plurality of attendees 116.

The system 102 may include suitable logic, circuitry, interfaces, and or code that may be configured to receive the plurality of images 114 of the plurality of attendees 116 related to a plurality of meeting sessions (such as a meeting session 118 shown, for example, in FIG. 1) attended by the corresponding attendees. The system 102 may be configured to calculate an attention score for each of the plurality of attendees based on the received plurality of images 114 and further train the plurality of ML models 106 for the plurality of attendees 116 based on the calculated attention score for each of the plurality of attendees 116. Examples of the system 102 may include, but are not limited to an educational engine, a computer workstation, a mainframe machine, a server, a smartphone, a cellular phone, a mobile phone, a computing device such as a personal computer with or without a Graphics Processing Unit (GPU), an imaging device with processing capabilities, and/or a consumer electronic (CE) device. In an embodiment, the system 102 may be also implemented as a plugin that may be added to existing video teleconferencing software programs and applications.

Each of the plurality of image capture devices 104 may include suitable logic, circuitry, and interfaces that may be configured to capture the plurality of images 114 of the plurality of attendees 116. Each of the plurality of image capture devices 104 may be further configured to transmit the captured plurality of images 114 to the system 102. Examples of each of the plurality of image capture devices 104 may include, but are not limited to, an image sensor, a closed-circuit television (CCTV) camera, a web camera (or a webcam), a wide-angle camera, an action camera, a camcorder, a digital camera, camera phones, a time-of-flight camera (ToF camera), a night-vision camera, and/or other image capture devices. In an embodiment, the plurality of image capture devices 104 may include a depth sensor that may be configured to capture depth information/a plurality of depth values of the plurality of attendees 116 from a single viewpoint or from a plurality of viewpoints in the corresponding meeting sessions (such as classrooms).

Each of the plurality of Machine Learning (ML) models 106 may be an untrained classifier/regression/clustering model which may need to be trained to identify a relationship between inputs, such as features in a training dataset and output a set of recommendations. Each of the plurality of ML models 106 may be defined by its hyper-parameters, for example, number of weights, cost function, input size, number of layers, and the like. The parameters of the each of the plurality of ML models 106 may be tuned and weights may be updated so as to move towards a global minima of a cost function for the corresponding ML model. After several epochs of the training on the feature information in the training dataset, each of the plurality of ML models 106 may be trained to output a prediction/classification result for a set of inputs. The prediction result may be indicative of a class label for each input of the set of inputs. In an embodiment, each of the plurality of ML models 106 may be trained for different attendee based on the attention scores calculated from the past meeting sessions attended by the corresponding attendee, where different meeting sessions may have different meeting categories.

Each of the plurality of ML models 106 may include electronic data, which may be implemented as, for example, a software component of an application executable on the system 102. Each of the plurality of ML models 106 may rely on libraries, external scripts, or other logic/instructions for execution by a processing device, such as circuitry. Each of the plurality of ML models 106 may include code and routines configured to enable a computing device, such as the system 102 to perform one or more operations to output the set of recommendations. Additionally, or alternatively, each of the plurality of ML models 106 may be implemented using hardware including a processor, a microprocessor (e.g., to perform or control performance of one or more operations), a field-programmable gate array (FPGA), or an application-specific integrated circuit (ASIC). Alternatively, in some embodiments, the each of the plurality of ML models 106 may be implemented using a combination of hardware and software.

In an embodiment, each of the plurality of ML models 106 may be implemented as a neural network model, such as, a deep learning model. The neural network model may be defined by its hyper-parameters and topology/architecture. For example, the neural network model may be a deep neural network-based model that may have a number of nodes (or neurons), activation function(s), number of weights, a cost function, a regularization function, an input size, a learning rate, number of layers, and the like. Such a model may be referred to as a computational network or a system of nodes (for example, artificial neurons). For a neural network implementation, the nodes of the neural network model may be arranged in layers, as defined in a neural network topology. The layers may include an input layer, one or more hidden layers, and an output layer. Each layer may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the model. Outputs of each hidden layer may be coupled to inputs of at least one node in other layers of the neural network model. Node(s) in the final layer may receive inputs from at least one hidden layer to output a result. The number of layers and the number of nodes in each layer may be determined from the hyper-parameters, which may be set before, while, or after training the neural network model on a training dataset.

Each node of the neural network model may correspond to a mathematical function (e.g., a sigmoid function or a rectified linear unit) with a set of parameters, tunable during training of the model. The set of parameters may include, for example, a weight parameter, a regularization parameter, and the like. Each node may use the mathematical function to compute an output based on one or more inputs from nodes in other layer(s) (e.g., previous layer(s)) of the neural network model. All or some of the nodes of the neural network model may correspond to same or a different mathematical function.

In training of the neural network model, one or more parameters of each node may be updated based on whether an output of the final layer for a given input (from the training dataset) matches a correct result based on a loss function for the neural network model. The above process may be repeated for the same or a different input till a minima of loss function is achieved, and a training error is minimized. Several methods for training are known in the art, for example, gradient descent, stochastic gradient descent, batch gradient descent, gradient boost, meta-heuristics, and the like.

In certain embodiments, each of the plurality of ML models 106 may be based on a hybrid architecture of multiple Deep Neural Networks (DNNs). Examples of each of the plurality of ML models 106 may include, but are not limited to, a neural network model or a model based on one or more of regression method(s), instance-based method(s), regularization method(s), decision tree method(s), Bayesian method(s), clustering method(s), association rule learning, and dimensionality reduction method(s). Examples of the neural network model may include, but are not limited to, an artificial neural network (ANN), a deep neural network (DNN), a convolutional neural network (CNN), a recurrent neural network (RNN), a CNN-recurrent neural network (CNN-RNN), R-CNN, Fast R-CNN, Faster R-CNN, a Residual Neural Network (Res-Net), a Feature Pyramid Network (FPN), and/or a combination thereof.

The audio capture device 108 may include suitable logic, circuitry, and/or interfaces that may be configured to capture a verbal interaction (in form of audio signals) between each of the plurality of attendees 116 and an educator of the corresponding meeting session. Examples of the audio capture device 108 may include, but are not limited to, a recorder, an electret microphone, a dynamic microphone, a carbon microphone, a piezoelectric microphone, a fiber microphone, a (micro-electro-mechanical systems) MEMS microphone, or other microphones known in the art. The audio capture device 108 may be positioned in proximity to the attendees and to the educators to capture the verbal interactions during different meeting sessions.

The server 110 may include suitable logic, circuitry, interfaces, and code that may be configured to store the received plurality of images 114 of the plurality of attendees 116 related to the plurality of meeting sessions. In some embodiments, the server 110 may be configured to train and store each of the plurality of ML models 106 for each of the plurality of attendees 116. In some embodiments, the server 110 may be configured to store content presented (or to be presented) during the meeting session and store profile information related to different attendees and educators. In an embodiment, the server 110 may be implemented as a cloud server which may execute operations through web applications, cloud applications, HTTP requests, repository operations, file transfer, and the like. Other examples of the server 110 may include, but are not limited to a database server, a file server, a web server, a media server, an application server, a mainframe server, a cloud server, or other types of servers. In one or more embodiments, the server 110 may be implemented as a plurality of distributed cloud-based resources by use of several technologies that are well known to those skilled in the art. A person with ordinary skill in the art will understand that the scope of the disclosure may not be limited to implementation of the server 110 and the system 102 as separate entities. In certain embodiments, the functionalities of the server 110 may be incorporated in its entirety or at least partially in the system 102, without departure from the scope of the disclosure.

The communication network 112 may include a communication medium through which the system 102, the plurality of image capture devices 104, the audio capture device 108, and the server 110 may communicate with each other. The communication network 112 may be a wired or wireless communication network. Examples of the communication network 112 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the network environment 100 may be configured to connect to the communication network 112, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

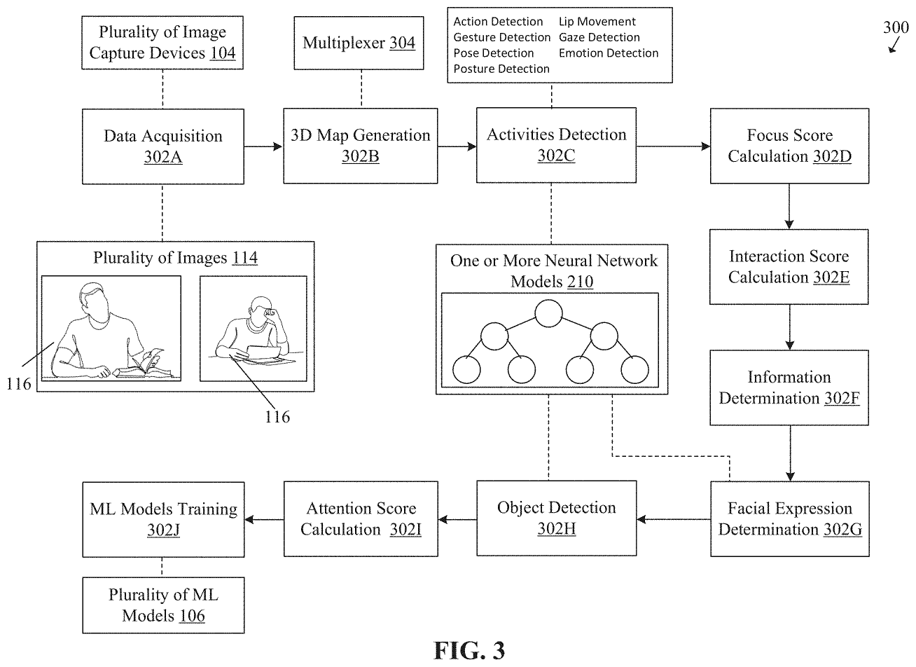

In operation, the system 102 may be configured to receive the plurality of images 114 of the plurality of attendees 116 related to the plurality of meeting sessions (like meeting sessions attended by different attendees in past). The plurality of images 114 may be received from the plurality of image capture devices 104 positioned at different meeting sessions. A meeting category for one or more meeting sessions of the plurality of meeting sessions may be different and may correspond to at least one of a type of meeting session, a number of attendees in the meeting session, a duration of the meeting session, an average age of the attendees in the meeting session, a topic of the meeting session, an experience of the educator of the meeting session, or content presented in the meeting session. The system 102 may further detect one or more activities that may be performed by each of the plurality of attendees 116 during the corresponding meeting sessions. The one or more activities may be detected based on the received plurality of images 114. In an embodiment, the detected one or more activities performed by each of the plurality of attendees 116 may be associated with at least one of an action performed by an attendee, a gesture performed by the attendee, a head pose of the attendee, a body posture of the attendee, a lip movement of the attendee, a gaze of the attendee, or a facial emotion of the attendee. In other words, the one or more activities may indicate at least one of: a focus level of the attendee or an interaction level between the attendee and the educator. Details about the detection of the one or more activities are provided, for example, in FIG. 3.

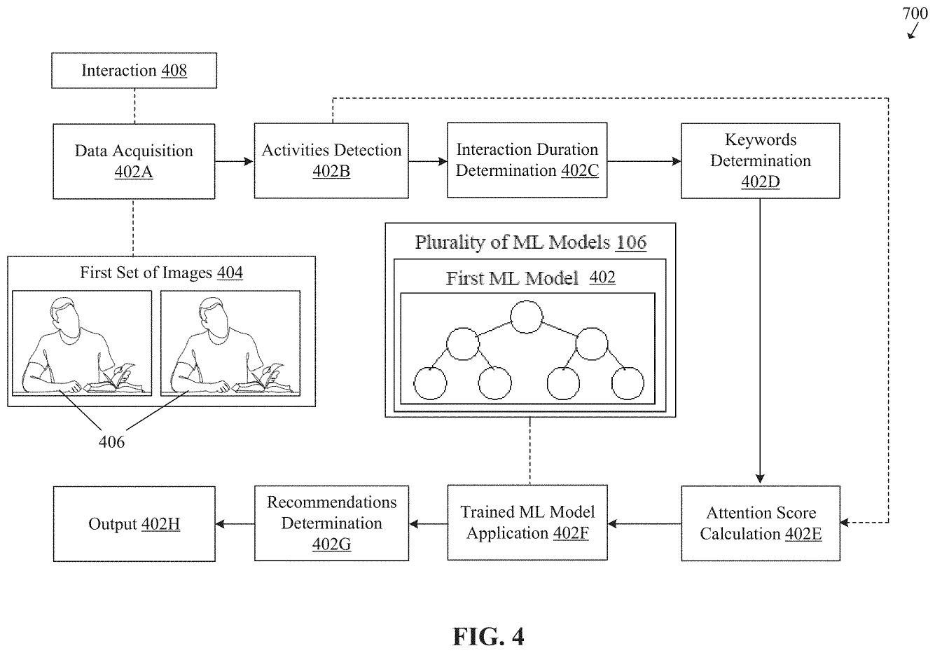

In an embodiment, the system 102 may be configured to control the audio capture device 108 to capture the interaction between the plurality of attendees 116 and the educator of the corresponding meeting session. In some embodiments, the system 102 may directly receive a plurality of audio signals (i.e. captured by the corresponding audio capture devices during different meeting sessions) from the server 110. The system 102 may further determine one or more keywords in the captured interaction based on the captured interaction. Details about the determination of the one or more keywords are provided, for example, in FIG. 4.

The system 102 may be further configured to calculate an attention score for each of the plurality of attendees for the corresponding period of time based on the detected one or more activities related to the corresponding attendee and performed during different meeting sessions. In another embodiment, the system 102 may be further configured to calculate the attention score for each of the plurality of attendees for the corresponding period of time, based on the detected one or more activities related to the corresponding attendee and the captured interaction of the corresponding attendee with the educator. The attention score may indicate a level of attention of each attendee in the corresponding meeting sessions. Details of the calculation of the attention level are provided, for example, in FIG. 3. The system 102 may be further configured to train each of the plurality of ML models 106 for each of the plurality of attendees 116 based on the calculated attention scores for each of the plurality of attendees 116 and based on the meeting categories of the corresponding meeting sessions.

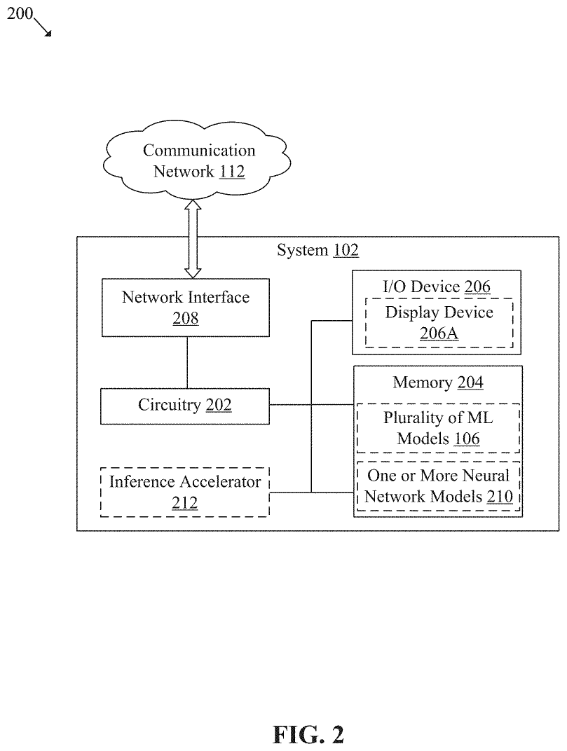

Based on the training of the plurality of ML models 106, the system 102 may be configured to store the trained plurality of ML models 106 in a memory (i.e. a memory 204 in FIG. 2) and apply the plurality of ML models 106 in a real-life scenario. In the real-life scenario, the system 102 may be configured to receive a first set of images of a first attendee of the plurality of attendees 116. The first attendee may be related to a first meeting session (i.e. recent meeting session) which may be different from the plurality of meeting sessions (i.e. past meeting sessions based on which the plurality of ML models 106 are trained). The system 102 may further detect a first set of activities that may be performed by the first attendee during the first meeting session over a first period of time (for example for certain minutes during the meeting session). The system 102 may further calculate a first attention score associated with the first attendee for the first period of time based on the detected first set of activities. The first attention score may indicate a level of attention of the first attendee in the first meeting session. The system 102 may further apply a first machine learning (ML) model of the plurality of ML models 106 on the calculated first attention score. The first machine learning (ML) model may be personalized for the first attendee or trained based on the historical data (i.e. attention scores, meeting categories, recommendations, other factors like facial expression (or emotions) of the attendee, experience of educators, preferences/interests of the attendee, environmental conditions of the meeting session, response time of the attendee, and the like) related to the first attendee. The system 102 may further determine a first set of recommendations based on the application of the first ML model on the calculated first attention score of the first attendee and further output the determined first set of recommendations for either the first attendee, an educator of the first meeting session, or the content presented during the first meeting session. Details about the application of the trained first ML model and the set of recommendations are provided for example, in FIG. 4.

FIG. 2 is a block diagram that illustrates an exemplary system for meeting session control based on attention determination, in accordance with an embodiment of the disclosure. FIG. 2 is explained in conjunction with elements from FIG. 1. With reference to FIG. 2, there is shown a block diagram 200 of the system 102. The system 102 may include circuitry 202 which may perform operations for training of the plurality of ML models 106 and further apply the trained plurality of ML models 106 for meeting session control based on the attention determination. The system 102 may further include a memory 204, an input/output (I/O) device 206, a network interface 208, one or more NN models 210, and an inference accelerator 212. The memory 204 may include the plurality of ML models 106 and the one or more neural network (NN) models 210. The circuitry 202 may be communicatively coupled to the memory 204, the I/O device 206, the network interface 208, and the inference accelerator 212.

The circuitry 202 may include suitable logic, circuitry, and interfaces that may be configured to execute program instructions associated with different operations to be executed by the system 102. For example, some of the operations may include reception of the plurality of images 114, detection of the one or more activities, calculation of the attention score, training of the plurality of ML models 106, application of the trained ML model, and determination of the recommendations. The circuitry 202 may include one or more specialized processing units, which may be implemented as a separate processor. In an embodiment, the one or more specialized processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an ×86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may comprise suitable logic, circuitry, interfaces, and/or code that may be configured to store the received plurality of images 114, the trained plurality of ML models 106, and the one or more NN models 210. The memory 204 may be further configured to store a first three-dimensional (3D) map of the meeting session, a focus score of the attendee, an interaction score of the attendee, a facial expression of each of the plurality of attendees 116, experience information of the educators of the meeting session, profile information of the attendees, environment information of the meeting sessions, the first set of images and dashboard information. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, and interfaces that may be configured to receive the user input(s) and provide an output based on the received user input(s). The user inputs may include, but is not limited to, a request to provide recommendation for a particular meeting session, a request to provide dashboard information, experience information about a particular educator, or profile information about a particular attendee. The I/O device 206 which may include various input and output devices, which may be configured to communicate with the circuitry 202. Examples of the I/O device 206 may include, but are not limited to, a display device 206A, an audio rendering device, a touch screen, a keyboard, a mouse, a joystick, and a microphone.

The display device 206A may include suitable logic, circuitry, and interfaces that may be configured to display, but is not limited, the dashboard information including statistics about the attention scores for particular attendee (or about the meeting sessions), or the recommendation information for the attendees, the educators, content creators, or authorities related to the meeting sessions. The display device 206A may be a touch screen which may enable a user to provide a user-input via the display device 206A. The touch screen may be at least one of a resistive touch screen, a capacitive touch screen, or a thermal touch screen. The display device 206A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 206A may refer to a display screen of a head mounted device (HMD), a smart-glass device, a see-through display, a projection-based display, an electro-chromic display, or a transparent display.

The network interface 208 may include suitable logic, circuitry, and interfaces that may be configured to facilitate communication between the circuitry 202, the plurality of image capture devices 104, the audio capture device 108, and the server 110, via the communication network 112. The network interface 208 may be implemented by use of various known technologies to support wired or wireless communication of the system 102 with the communication network 112. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 208 may be configured to communicate via wireless communication with networks, such as the Internet, an Intranet or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

Each of one or more NN models 210 may be a computational network or a system of artificial neurons, arranged in a plurality of layers, as nodes. The plurality of layers of each of one or more NN models 210 may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of each of one or more NN models 210. Outputs of each hidden layer may be coupled to inputs of at least one node in other layers of each of the one or more NN models 210. Node(s) in the final layer may receive inputs from at least one hidden layer to output a result. The number of layers and the number of nodes in each layer may be determined from hyper-parameters of each of one or more NN models 210. Such hyper-parameters may be set before, while training, or after training of each of one or more NN models 210 on a training dataset. Each node of each of one or more NN models 210 may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of each of one or more NN models 210. All or some of the nodes of each of one or more NN models 210 may correspond to the same or a different mathematical function.

The training of each of one or more NN models 210 may include updating one or more parameters of each node based on whether an output of the final layer for a given input (from the training dataset) matches a correct result based on a loss function for each of one or more NN models 210. The above process may be repeated for the same or a different input till a minima of loss function may be achieved, and a training error may be minimized. Several methods for training are known in art, for example, gradient descent, stochastic gradient descent, batch gradient descent, gradient boost, meta-heuristics, and the like.

Each of one or more NN models 210 may include electronic data, which may be implemented as, for example, a software component of an application executable on the system 102. Each of one or more NN models 210 may rely on libraries, external scripts, or other logic/instructions for execution by a processing device, such as the circuitry 202. Each of one or more NN models 210 may include code and routines configured to enable a computing device, such as the circuitry 202 to perform one or more operations for detection of one or more activities performed by the plurality of attendees. Additionally, or alternatively, the each of one or more NN models 210 may be implemented using hardware including a processor, a microprocessor (e.g., to perform or control performance of one or more operations), a field-programmable gate array (FPGA), or an application-specific integrated circuit (ASIC). Alternatively, in some embodiments, the each of one or more NN models 210 may be implemented using a combination of hardware and software. Examples of one or more NN models 210 may include, but are not limited to, a deep neural network (DNN), a convolutional neural network (CNN), Artificial neural network (ANN), CNN+ANN, R-CNN, Fast R-CNN, Faster R-CNN, (You Only Look Once) YOLO network, a fully connected neural network, and/or a combination of such networks.

The inference accelerator 212 may include suitable logic, circuitry, interfaces, and/or code that may be configured to operate as a co-processor for the circuitry 202 to accelerate computations associated with the operations of one or more NN models 210 and/or the plurality of ML models 106. For instance, the inference accelerator 212 may accelerate the computations on the system 102 such that one or more activities may be detected in less time than what is typically incurred without the use of the inference accelerator 212. The inference accelerator 212 may implement various acceleration techniques, such as parallelization of some or all of the operations of one or more NN models 210 and/or the plurality of ML models 106. The inference accelerator 212 may be implemented as a software, a hardware, or a combination thereof. Example implementations of the inference accelerator 212 may include, but are not limited to, a GPU, a Tensor Processing Unit (TPU), a neuromorphic chip, a Vision Processing Unit (VPU), a field-programmable gate arrays (FGPA), a Reduced Instruction Set Computing (RISC) processor, an Application-Specific Integrated Circuit (ASIC) processor, a Complex Instruction Set Computing (CISC) processor, a microcontroller, and/or a combination thereof.

FIG. 3 is diagram that illustrates exemplary operations for training a ML model for each of a plurality of attendees related to a plurality of meeting sessions, in accordance with an embodiment of the disclosure. FIG. 3 is explained in conjunction with elements from FIG. 1 and FIG. 2. With reference to FIG. 3, there is shown a block diagram 300 that illustrates exemplary operations from 302A to 302J, as described herein. The exemplary operations illustrated in the block diagram 300 may start at 302A and may be performed by any computing system, apparatus, or device, such as by the system 102 of FIG. 1 or the circuitry 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302A, a data acquisition operation may be performed. In the data acquisition operation, the circuitry 202 may be configured to receive the plurality of images 114 of the plurality of attendees 116 related to a plurality of meeting sessions. In an embodiment, the circuitry 202 may control the plurality of image capture devices 104 for a period of time (for example for certain days, weeks, months, or years) to capture the plurality of images 114 of the plurality of attendees 116. The circuitry 202 may further receive the captured plurality of images 114 from the plurality of image capture devices 104. In some embodiments, the circuitry 202 may receive the plurality of images 114 of the plurality of attendees 116 (i.e. who attended corresponding meeting sessions) from the server 110.

In an embodiment, each of the meeting session (such as a classroom shown, for example, in FIG. 1) may include the plurality of image capture devices 104 installed at different locations of the meeting session to capture the images of the attendees from different viewpoints. In such case, the plurality of image capture devices 104 may include, but not limited to, a first image capture device, a second image capture device, and a third image capture device. The first image capture device may capture at an axial image plane (i.e. on x-y axis), the second image capture device may capture at an orthogonal image plane (i.e. on y-z axis), and the third image capture device may capture at a sagittal image plane (i.e. on x-z axis). In an embodiment, the second image capture device and the third image capture device may be optional, and the first image capture device may capture the images of the attendees present in a particular meeting session. In an embodiment, the first image capture device may include a depth sensor (such as a RGBD camera) to capture the images of the attendees with depth information (indicating a distance between the first image capture device to each of the attendees).

In an embodiment, the meeting session may be a classroom-based (i.e. offline based) session as shown, for example, in FIG. 1. In such case, examples of the meeting session may include, but are not limited to, a classroom of an educational institute, a physical meeting of a professional institution, a physical conference, a physical seminar, or a physical training room. In another embodiment, the meeting session may be an online-based session such as, but not limited to, an online classroom, an online meeting session, an online training session, a web-conference, or a webinar. In such case, the plurality of image capture devices 104 (such as CCTV) may be positioned in a room (or in any physical enclosure) from where the attendees may attend the corresponding online meeting session. In certain cases, the plurality of image capture devices 104 (such Webcam) may be integrated (or inbuilt or coupled) to a computing device (such a mobile phone, personal computer, or laptop) from which the attendees may attend the corresponding online meeting session.

In an embodiment, a meeting category for one or more meeting sessions of the plurality of meeting sessions may be different. The meeting category may correspond to at least one of: a type of meeting session, a number of attendees in the meeting session, a duration of the meeting session, an average age of the attendees in the meeting session, a topic of the meeting session, an experience of an educator of the meeting session, or content presented in the meeting session. In an embodiment, examples of different types of the meeting sessions may include, but are not limited to, a classroom-based session with educator, a classroom-based session without educator, an online-based session with educator, an online-based session without educator. The number of attendees may indicate a number of attendees present in a particular meeting session, for example, a low strength meeting (i.e. 1-10 attendees or less than 30% meeting strength), a medium strength meeting (i.e. 11-20 attendees or 31-60% meeting strength), or a high strength meeting (i.e. more than 20 attendees or more than 60% meeting strength). The duration of the meeting session may indicate whether the meeting session is of a short duration (for example less than 30 mins) or a long duration (for example more than an hour). The average age of the attendees may indicate an age group or an educational year of the attendees (for example preschool attendees, primary standard attendees, senior standard attendees, first-year graduation attendees, final-year graduation attendees, 3-6 years age group attendees, 12-17 years age group attendees, 21-30 years age group attendees, or 35+ years age group attendees). The topic of the meeting session may indicate an agenda of the meeting session (for example, but not limited to, a subject of the meeting session, a particular chapter of the curriculum, a topic of a technology or a business field, a specific plan discussed during the meeting session, or a specific problem discussed during the meeting session). The experience of the educator may indicate a number of years of teaching (or training) experience of the educator (or a teacher, trainer, or instructor), for example, less than a year experience, 2-5 years' experience, 6-10 years' experience, or more than 10 years' experience. The content presented in the meeting session may indicate whether the content presented is related to theoretical content, content including several practical examples, or an interactive content.

In an embodiment, the disclosed system 102 may consider the images of the attendees of different categories of the meeting sessions, because different meeting categories may influence or impact the attention levels of the attendees. Therefore, the system 102 may track the attention scores of a particular attendee for different categories of the meeting sessions for a particular period of time (for example for certain months or years) to effectively train a personalized ML model with diverse and robust training data about the particular attendee.

At 302B, a 3D map generation operation may be performed. In the 3D map generation operation, the circuitry 202 may be configured to generate a first three-dimensional (3D) map of the corresponding meeting session including at least one of the plurality of attendees 116. The generation of the first 3D map may correspond to a profiling of the corresponding meeting session (i.e. including at least one of the plurality of attendees 116) in three dimensions to map the present objects or attendees in real-world. The circuitry 202 may generate the first 3D map of the meeting session based on the captured plurality of images 114 of the meeting session including the corresponding attendees. In an embodiment, the system 102 may include a video (or imaging) multiplexer 304 that may combine the plurality of images 114 captured by the first image capture sensor, the second image capture sensor, and the third image capture sensor for a particular meeting session. The system 102 may further control the multiplexer 304 to generate the first 3D map of the meeting session. In an embodiment, the system 102 may utilize the depth information (for example captured by the depth sensor in the image capture device) to generate the first 3D map for the meeting session including corresponding attendees.

At 302C, an activities detection operation may be performed. In the activities detection operation, the circuitry 202 may be configured to detect one or more activities that may be performed by each of the plurality of attendees 116 during the corresponding meeting sessions. The circuitry 202 may detect the one or more activities of the particular attendee based on the received plurality of images 114 about the corresponding meeting sessions attended by the attendee. In an embodiment, the circuitry 202 may be configured to apply one or more neural network (NN) models 210 on the received plurality of images 114 or on the generated first 3D map of the meeting session to detect the one or more activities of the corresponding attendee over the period of time (for example for certain minutes or hours during the meeting session).

In an embodiment, the one or more activities performed by each of the plurality of attendees 116 may be associated with at least one of: an action performed by an attendee, a gesture performed by the attendee, a head pose of the attendee, a body posture of the attendee, a lip movement of the attendee, a gaze of the attendee, or a facial emotion of the attendee (as shown in FIG. 3). Examples of one or more activities associated with the action performed by the attendee may include, but are not limited to, writing, typing, talking, asking, yawning, carrying an object, performing group activity, and the like. The one or more activities associated with the gesture performed by the attendee may indicate whether the attendee is making a pre-defined gesture to perform an action such as (but not limited to) asking for a permission to go out for a break during the meeting session raising a hand, or pointing to something/someone during the particular period of time. The one or more activities associated with the lip movement of the attendee may indicate whether the attendee is reading or talking with another attendee. The one or more activities associated with the body posture of the attendee may indicate whether the attendee is sitting or standing and the like, during the period of time. The one or more activities associated with the gaze of the attendee may indicate whether the attendee is focused or not during the period of time of the meeting session. The one or more activities associated with the head pose of the attendee may indicate whether the attendee is, turning left, turning right, present, absent, or the head of the attendee is down during the period of time of the meeting session.

In an embodiment, the circuitry 202 may be configured to detect the one or more activities for the attendees over a set of timeslots within the period of time. The circuitry 202 may detect at least one activity of the one or more activities (i.e. performed by the plurality of attendees 116) in each of the set of timeslots within the period of time. For example, if the period of time is of “10” minutes, then each of the set of timeslots may be of “1” minute or certain seconds each. In an embodiment, each of the set of timeslots may correspond to a particular number of images frames during which a particular activity of the attendee is detected using the corresponding plurality of images 114. The circuitry 202 may generate a timeline that includes the set of timeslots and the detected activity in each timeslot for each of the plurality of attendees 116 for a particular meeting session, as shown below in Table 1:

TABLE 1
Exemplary timeline of the detected activities for different
attendees of corresponding meeting sessions.

| Timeslot | 1 | 2 | 3 | 4 | 5 | 6 | 7 | 8 | 9 | 10 |
|---|---|---|---|---|---|---|---|---|---|---|
| Attendee 1 | AQ | FM | F | F | AQ | F | E | E | S | FM |
| Attendee 2 | FM | T | S | E | E | RH | FM | S | RH | S |
| Attendee N | FM | W | R | R | F | F | RH | W | W | FM |

The parameters in Table 1 are as follows:
AQ indicates that the attendee is answering a question in the meeting session,
F indicates that the attendee is focused on the content in the meeting session,
RH indicates that the attendee is raising hand in the meeting session,
R indicates that the attendee is reading in the meeting session,
W indicates that the attendee is writing or typing in the meeting session,
T indicates that the attendee is talking to someone in the meeting session,
E indicates that the attendee is not present at his designated seat in the meeting session (i.e., out of position),
S indicates that the attendee is standing in the meeting session, and
FM corresponds to frame not detected or activity not detected.

In an embodiment, based on the generated first 3D map of the meeting session, the circuitry 202 may determine a position of each attendee in the meeting session (for example in a physical classroom based meeting session). The circuitry 202 may associate or tag a particular seat with the position of the attendee based on the generated first 3D map of the meeting session. The tagging of the attendee with the particular seat may help to recognize the attendee during rest of the meeting session and identify the activities performed by the same attendee while sitting on the same seat tagged to the attendee. Similarly, the circuitry 202 may determine a position of each of the plurality of attendees 116 in the corresponding meeting session based on the received plurality of images 114 and the determined 3D map of each meeting session. Further, the circuitry 202 may associate each attendee of the plurality of attendees 116 with different seats in the respective meeting sessions. Based on such seat tagging, the circuitry 202 may determine at which position (at front, back, middle, or corner) in the meeting session, the particular attendee was sitting and performing different activities while attending the respective meeting session. Thus, based on the seat tagging performed by the disclosed system 102, different actions (or activities or interactions) may be tied to corresponding attendee in different meeting sessions.

At 302D, a focus score calculation operation may be performed. In the focus score calculation operation, the circuitry 202 may be configured to calculate a focus score for each of the plurality of attendees 116 for the corresponding meeting sessions attended by each attendee. The circuitry 202 may calculate the focus score for each of the plurality of attendees 116 based on the detected one or more activities related to the corresponding attendee. In other words, the circuitry 202 may calculate the focus score for a particular attendee for a particular meeting session. Specifically, the focus score may be calculated based on the detection of a first set of activities of the one or more activities. Such first set of activities may include, but are not limited to, the action performed by an attendee (such as writing, typing, talking, yawning), the gaze of the attendee, the head pose of the attendee, the body posture of the attendee, and the lip movement of the attendee (such as in reading or talking to other attendees).

In an embodiment, the circuitry 202 may be configured to determine a first duration of at least one of the one or more activities performed by each of the plurality of attendees during the corresponding meeting sessions. Specifically, the circuitry 202 may be configured to determine the first duration of each of the first set of activities. Based on the determined first duration, the circuitry 202 may be configured to assign a score for each of the first set of activities. In an embodiment, the circuitry 202 may be configured to allocate scores or points (like, but not limited to, writing related points, reading related points, gaze related points, or speaking related points) for different activities to each of the plurality of attendees 116 based on the captured plurality of images 114 of the corresponding meeting sessions. In an embodiment, the determined first duration may indicate time spent by an attendee for different activities and may be further used to tag the attendee as an “attention seeker” and/or attentive attendee.

To allocate the reading related points, the circuitry 202 may be configured to determine a strength (i.e. number of attendees) of each meeting session of the plurality of meeting sessions. The circuitry 202 may further compare the determined strength of the meeting session with a threshold strength (for example 30% strength). In case, the determined strength is greater than the threshold strength, the system 102 may apply a read formula to allocate the reading related points to each of the plurality of attendees 116 that may be present in the meeting session. The reading related formula may be applied by equation (1) as follows:

R=Σₜ₌₀ⁿG_{t·}^{k}(S)*[(P1C1+P2C2+P3C3+P4C4+P5C5+P6C6)] (1)

where,
R corresponds to the reading related points or scores,
C corresponds to a type of meeting session,
k corresponds to duration of the reading activity in seconds/minutes (i.e. first duration),
S corresponds to the strength of the meeting session,
C1 corresponds to a webinar meeting session with the educator,
C2 corresponds to the webinar meeting session without the educator,
C3 corresponds to a classroom meeting session with the educator,
C4 corresponds to the classroom meeting session without the educator,
C5 corresponds to an interactive/activity meeting session with the educator,
C6 corresponds to an interactive/activity meeting session without the educator,
Cn=0 or 1. If the C1=1, then C2=C3=C4=C5=C6-0, and
P1, P2, P3, P4, P5, and P6 corresponds to weight variables with values between 0 and 1.

In an embodiment, if a percentage of the number of attendees (A) (i.e. strength), who may be present/attending the meeting session, is greater than 50% and the duration of reading activity for the attendees is greater than equal to 10 seconds but less than equal to 40 seconds, then each of the plurality of attendees 116 who are reading may be allocated with the reading related points of “0.9”, whereas the leftover attendees (i.e. other than those who were reading) may be allocated with the reading related points of “0.1” for a particular meeting session. In another embodiment, if the percentage of the number of attendees (A), who may be present/attending the meeting session, is greater than 50% and the duration of the reading activity for the attendees is greater than 40 seconds, then each of the plurality of attendees 116 who are reading may be allocated with the reading related points of “1”, whereas the leftover attendees (i.e. other than those who were reading) may be allocated with the reading related points of “0”. In another embodiment, if the percentage of the number of attendees (A), who may be present/attending the meeting session, is greater than 50% and the duration of the reading activity for the attendees is less than 10 seconds, then each of the plurality of attendees 116 who are reading may be allocated with the reading related points of 0, whereas the leftover attendees (i.e. other than those who were reading) may be allocated with the reading related points of 0.

In an embodiment, if the percentage of the number of attendees (A), who may be present/attending the meeting session, is less than 25% and the duration of the reading activity for the attendees is greater than 40 seconds, then each of the plurality of attendees 116 who are reading may be allocated with the reading related points of “0.5”, whereas the leftover attendees (i.e. other than those who were reading) may be allocated with the reading related points of “0.5”. In another embodiment, if the percentage of the number of attendees (A), who may be present/attending the meeting session, is less than 25% and the duration of the reading activity for the attendees is less than 10 seconds, then each of the plurality of attendees 116 who are reading may be allocated with the reading related points of “0”, whereas the leftover attendees (i.e. other than those who were reading) may be allocated with the read points of “0”. In an embodiment, if the percentage of the number of attendees (A), who may be present/attending the meeting session, is less than 25% and the duration of reading activity for the attendees is greater than equal to 10 seconds but less than equal to 40 seconds, then each of the plurality of attendees 116 who are reading may be allocated with the reading related points of “0”, whereas the leftover attendees (i.e. other than those who were reading) may be allocated with the reading related points of 0.

In an embodiment, if a percentage of the number of attendees (A), who may be present/attending the meeting session, is greater than 25% but less than 50% and the duration of the reading activity for the attendees is greater than equal to 10 seconds but less than equal to 40 seconds, then each of the plurality of attendees 116 who are reading may be allocated with the reading related points of “0.8”, whereas the leftover attendees (i.e. other than those who were reading) may be allocated with the reading related points of “0.2”. In another embodiment, if the percentage of the number of attendees (A), who may be present/attending the meeting session, is greater than 25% but less than 50% and the duration of the reading activity for the attendees is greater than 40 seconds, then each of the plurality of attendees 116 who are reading may be allocated with the reading related points of “0.6”, whereas the leftover attendees (i.e. other than those who were reading) may be allocated with the reading related points of “0.4”. In another embodiment, if the percentage of the number of attendees (A), who may be present/attending the meeting session, is greater than 25% but less than 50% and the duration of the reading activity for the attendees is less than 10 seconds, then each of the plurality of attendees 116 who are reading may be allocated with the reading related points of 0, whereas the leftover attendees (i.e. other than those who were reading) may be allocated with the reading related points of 0. The exemplary relationship between the strength of the meeting session (i.e. number of the attendees (A)), duration of the reading activity, and the reading related points are provided in Table 2 below:

TABLE 2
Exemplary relationship between the strength of the meeting session,
duration of the reading activity, and the reading related points.

| No. of | Duration of | Reading related points | |
|---|---|---|---|
| Attendees | reading activity | | Remaining |
| (A) | (T in Seconds) | If Yes | Attendees |
| A < 25% | T > 40 s | 0.5 | 0.5 |
| | 10 s < T < 40 s | 0 | 0 |
| | T < 10 s | 0 | 0 |
| 25% < A < 50% | T > 40 s | 0.6 | 0.4 |
| | 10 s < T < 40 s | 0.8 | 0.2 |
| | T < 10 s | 0 | 0 |
| A > 50% | T > 40 s | 1.0 | 0 |
| | 10 s < T < 40 s | 0.9 | 0.1 |
| | T < 10 s | 0 | 0 |

In an embodiment, to allocate the writing related points, the circuitry 202 may be configured to determine the strength of each meeting session of the plurality of meeting sessions. The circuitry 202 may further compare the determined strength of the meeting session with a threshold strength (for example 30% strength). In case, the determined strength is greater than the threshold strength, the system 102 may apply a write formula to allocate the writing related points to each of the plurality of attendees 116 that may be present in the meeting session. The write formula may be applied by equation (2) as follows:

W=Σₖ₌₀ⁿ(ₖⁿ)(S)*[(P1C1+P2C2+P3C3+P4C4+P5C5+P6C6)] (2)

where,
W corresponds to the writing related points or scores,
C corresponds to a type of meeting session,
k corresponds to duration of the writing activity in seconds or minutes (i.e. first duration),
S corresponds to strength of the meeting session,
C1 corresponds to a webinar meeting session with the educator,
C2 corresponds to the webinar meeting session without the educator,
C3 corresponds to a classroom meeting session with the educator,
C4 corresponds to the classroom meeting session without the educator,
C5 corresponds to an interactive/activity meeting session with the educator,
C6 corresponds to an interactive/activity meeting session without the educator,
Cn=0 or 1. If the C1=1, then C2=C3=C4=C5=C6-0, and
P1, P2, P3, P4, P5, and P6 corresponds to weight variables with values between 0 and 1

In an embodiment, if a percentage of the number of attendees (A), who may be present/attending the meeting session, is greater than 50% and the duration of the writing activity for the attendees is greater than equal to 3 seconds but less than equal to 15 seconds, then each of the plurality of attendees 116 who are writing may be allocated with the writing related points of “0.9”, whereas the leftover attendees (i.e. other than those who were writing) may be allocated with the writing related points of “0.1”. In another embodiment, if the percentage of the number of attendees (A), who may be present/attending the meeting session, is greater than 50% and the duration of the writing activity for the attendees is greater than 15 seconds, then each of the plurality of attendees 116 who are writing may be allocated with the writing related points of “1.0”, whereas the leftover attendees (i.e. other than those who were writing) may be allocated with the writing related points of 0. In another embodiment, if the percentage of the number of attendees (A), who may be present/attending the meeting session, is greater than 50% and the duration of the writing activity for the attendees is less than 3 seconds, then each of the plurality of attendees 116 who are writing may be allocated with the writing related points of 0, whereas the leftover attendees (i.e. other than those who were writing) may be allocated with the writing related points of 0.

In an embodiment, if the percentage of the number of attendees (A), who may be present/attending the meeting session, is less than 25% and the duration of the writing activity for the attendees is greater than 15 seconds, then each of the plurality of attendees 116 who are writing may be allocated with the writing related points of “0.5,” whereas the leftover attendees (i.e. other than those who were writing) may be allocated with the writing related points of “0.5”. In another embodiment, if the percentage of the number of attendees (A), who may be present/attending the meeting session, is less than 25% and the duration of the writing activity for the attendees is less than 3 seconds, then each of the plurality of attendees 116 who are writing may be allocated with the writing related points of 0, whereas the leftover attendees (i.e. other than those who were writing) may be allocated with the writing related points of 0. In an embodiment, if the percentage of the number of attendees (A), who may be present/attending the meeting session, is less than 25% and the duration of the writing activity for the attendees is greater than equal to 3 seconds but less than equal to 15 seconds, then each of the plurality of attendees 116 who are writing may be allocated with the writing related points of 0, whereas the leftover attendees (i.e. other than those who were writing) may be allocated with the writing related points of 0.

In an embodiment, if the percentage of the number of attendees (A), who may be present/attending the meeting session, is greater than 25% but less than 50% and the duration of the writing activity for the attendees is greater than equal to 3 seconds but less than equal to 15 seconds, then each of the plurality of attendees 116 who are writing may be allocated with the writing related points of “0.8”, whereas the leftover attendees (i.e. other than those who were writing) may be allocated with the writing related points of “0.2”. In another embodiment, if the percentage of the number of attendees (A), who may be present/attending the meeting session, is greater than 25% but less than 50% and the duration of the writing activity for the attendees is greater than 15 seconds, then each of the plurality of attendees 116 who are writing may be allocated with the writing related points of “0.6”, whereas the leftover attendees (i.e. other than those who were writing) may be allocated with the writing related points of “0.4”. In another embodiment, if the percentage of the number of attendees (A), who may be present/attending the meeting session, is greater than 25% but less than 50% and the duration of the writing activity for the attendees is less than 3 seconds, then each of the plurality of attendees 116 who are writing may be allocated with the writing related points of 0, whereas the leftover attendees (i.e. other than those who were writing) may be allocated with the writing related points of 0. The exemplary relationship between the strength of the meeting session (i.e. number of the attendees (A)), duration of the writing activity, and the writing related points are provided in Table 3 below:

TABLE 3
Exemplary relationship between the strength of the meeting session,
duration of the writing activity, and the writing related points.

| No. of | Duration of | Writing related points | |
|---|---|---|---|
| Attendees | writing activity | | Remaining |
| (A) | (T in Seconds) | If Yes | Attendees |
| A < 25% | T > 15 s | 0.5 | 0.5 |
| | 3 s < T < 15 s | 0 | 0 |
| | T < 3 s | 0 | 0 |
| 25% < A < 50% | T > 15 s | 0.6 | 0.4 |
| | 3 s < T < 15 s | 0.8 | 0.2 |
| | T < 3 s | 0 | 0 |
| A > 50% | T > 15 s | 1.0 | 0 |
| | 3 s < T < 15 s | 0.9 | 0.1 |
| | T < 3 s | 0 | 0 |

In an embodiment, to allocate the gaze related points, the circuitry 202 may be configured to determine the strength of each meeting session of the plurality of meeting sessions. The circuitry 202 may further compare the determined strength of the meeting session with a threshold strength (for example 30% strength). In case, the determined strength is greater than the threshold strength, the system 102 may apply a gaze formula to allocate the gaze related points to each of the plurality of attendees 116 that may be present in the meeting session. The gaze formula may be applied by equation (3) as follows:

$$X = {\sum }_{k = 0}^{n} ( \begin{matrix}n \\ k\end{matrix} ) . {( S )}^{*} [ ( P 1 C 1 + P 2 C 2 + P 3 C 3 + P 4 C 4 + P 5 C 5 + P 6 C 6 ) ] \qquad ( 3 )$$

where,
X corresponds to the gaze related points or scores,
C corresponds to a type of meeting session,
k corresponds to duration of the gazing activity in seconds or minutes (i.e. first duration),
S corresponds to strength of the meeting session,
C1 corresponds to a webinar meeting session with the educator,
C2 corresponds to the webinar meeting session without the educator,
C3 corresponds to a classroom meeting session with the educator,
C4 corresponds to the classroom meeting session without the educator,
C5 corresponds to an interactive/activity meeting session with the educator,
C6 corresponds to an interactive/activity meeting session without the educator.
Cn=0 or 1. If the C1=1, then C2=C3=C4=C5=C6-0, and
P1, P2, P3, P4, P5, and P6 corresponds to weight variables with values between 0 and 1

In an embodiment, if a percentage of the number of attendees (A), who may be present/attending the meeting session, is greater than 50% and the duration of the gazing activity for the attendees is greater than equal to 30 seconds but less than equal to 90 seconds, then each of the plurality of attendees 116 who are gazing may be allocated with the gaze related points of “0.9”, whereas the leftover attendees (i.e. other than those who were gazing) may be allocated with the gaze related points of “0.1”. In another embodiment, if the percentage of the number of attendees (A), who may be present/attending the meeting session, is greater than 50% and the duration of the gazing activity for the attendees is greater than 90 seconds, then each of the plurality of attendees 116 who are gazing may be allocated with the gaze related points of “1.0”, whereas the leftover attendees (i.e. other than those who were gazing) may be allocated with the gaze related points of 0. In another embodiment, if the percentage of the number of attendees (A), who may be present/attending the meeting session, is greater than 50% and the duration of the gazing activity for the attendees is less than 30 seconds, then each of the plurality of attendees 116 who are gazing may be allocated with the gaze related points of 0, whereas the leftover attendees (i.e. other than those who were gazing) may be allocated with the gaze related points of 0.

In an embodiment, if the percentage of the number of attendees (A), who may be present/attending the meeting session, is less than 25% and the duration of the gazing activity for the attendees is greater than 90 seconds, then each of the plurality of attendees 116 who are gazing may be allocated with the gaze related points of “0.5”, whereas the leftover attendees (i.e. other than those who were gazing) may be allocated with the gaze related points of “0.5”. In another embodiment, if the percentage of number of the attendees (A), who may be present/attending the meeting session, is less than 25% and the duration of the gazing activity for the attendees is less than 30 seconds, then each of the plurality of attendees 116 who are gazing may be allocated with the gaze related points of 0, whereas the leftover attendees (i.e. other than those who were gazing) may be allocated with the gaze related points of 0. In an embodiment, if the percentage of the number of attendees (A), who may be present/attending the meeting session, is less than 25% and the duration of the gazing activity for the attendees is greater than equal to 30 seconds but less than equal to 90 seconds, then each of the plurality of attendees 116 who are gazing may be allocated with the gaze related points of 0, whereas the leftover attendees (i.e. other than those who were gazing) may be allocated with the gaze related points of 0.

In an embodiment, if a percentage of the number of attendees (A), who may be present/attending the meeting session, is greater than 25% but less than 50% and the duration of the gazing activity for the attendees is greater than equal to 30 seconds but less than equal to 90 seconds, then each of the plurality of attendees 116 who are gazing may be allocated with the gaze related points of 0, whereas the leftover attendees (i.e. other than those who were gazing) may be allocated with the gaze related points of 0. In another embodiment, if the percentage of the number of attendees (A), who may be present/attending the first meeting session, is greater than 25% but less than 50% and the duration of gazing activity for the attendees is greater than 90 seconds, then each of the plurality of attendees 116 who are gazing may be allocated with the gaze related points of “0.5”, whereas the leftover attendees (i.e. other than those who were gazing) may be allocated with the gaze related points of “0.5”. In another embodiment, if the percentage of the number of attendees (A), who may be present/attending the meeting session, is greater than 25% but less than 50% and the duration of gazing activity for the attendees is less than 30 seconds, then each of the plurality of attendees 116 who are gazing may be allocated with the gaze related points of 0, whereas the leftover attendees (i.e. other than those who were gazing) may be allocated with the gaze related points of 0. The exemplary relationship between the strength of the meeting session (i.e. number of the attendees (A)), duration of the gazing activity, and the gaze related points are provided in Table 4 below:

TABLE 4
Exemplary relationship between the strength of the meeting session,
duration of the gazing activity, and the gaze related points.

| No. of | Duration of | Gaze related points | |
|---|---|---|---|
| Attendees | gazing activity | | Remaining |
| (A) | (T in Seconds) | If Yes | Attendees |
| A < 25% | T > 90 s | 0.5 | 0.5 |
| | 30 s < T < 90 s | 0 | 0 |
| | T < 30 s | 0 | 0 |
| 25% < A < 50% | T > 90 s | 0.6 | 0.4 |
| | 30 s < T < 90 s | 0.8 | 0.2 |
| | T < 30 s | 0 | 0 |
| A > 50% | T > 90 s | 1.0 | 0 |
| | 30 s < T < 90 s | 0.9 | 0.1 |
| | T < 30 s | 0 | 0 |

In an embodiment, the circuitry 202 may be configured to calculate the focus score based on the reading related points, the writing related points and the gaze related points. Specifically, the focus score for each of the plurality of attendees 116 may be calculated based on a summation of the reading related points, the writing related points and the gaze related points allocated to the corresponding attendee for the meeting session. The circuitry 202 may further store the calculated focus score in the memory 204 for a particular attendee for a particular meeting session.

At 302E, an interaction score calculation operation may be performed. In the interaction score calculation operation, the circuitry 202 may be configured to calculate an interaction score for each of the plurality of attendees 116 for activities performed in the corresponding meeting sessions. The circuitry 202 may calculate the interaction score for each of the plurality of attendees 116 based on the detected one or more activities performed by the corresponding attendee in different meeting sessions. In other words, the circuitry 202 may calculate the interaction score for a particular attendee for a particular meeting session. Specifically, the interaction score may be calculated based on the detection of a second set of activities of the one or more activities. Such second set of activities may include, but are not limited to, the gesture performed by the attendee (such as raising hand or activity participation), the gesture performed by the attendee (such as sitting or standing), and the lip movement of the attendee (such as in answering a question).

As an example, if a percentage of the number of attendees (A), who may be present/attending the meeting session, is greater than 30% and the attendees raise hand as well as speak, then each of the attendees who raised hands and spoken may be allocated with interaction points of “0.5”, whereas the leftover attendees may be allocated with the interaction points of “0.1”. If the attendee only speaks and may not raise hand or stand up, then the corresponding attendee may be allocated with the interaction points of “0.05” whereas the leftover attendees may be allocated with the interaction points of “0.2”. The interaction score (i.e. referred as ‘RA’) for each attendee may be further based on the allocated interaction points. The exemplary relationship between the strength of the meeting session (i.e. number of the attendees (A)), the activities performed by attendees, and the interaction points are provided in Table 5 below:

TABLE 5
Exemplary relationship between the strength of the meeting session,
the activities performed by attendees, and the interaction points.

| No. of | Activities Performed | | | Interaction Points | |
|---|---|---|---|---|---|
| Attendees | Raise | | Standing | | Remaining |
| (A) | Hands | Speaking | Up | If Yes | Attendees |
| A < 10% | Yes | — | — | 0.2 | 0.05 |
| 10% < A < 30% | Yes | — | — | 0.15 | 0.05 |
| A > 30% | Yes | — | — | 0.3 | 0 |
| | Yes | Yes | — | 0.5 | 0.1 |
| | — | Yes | — | 0.05 | 0.2 |
| | — | Yes | Yes | 0.2 | 0 |
| | Yes | Yes | Yes | 0.4 | 0 |

The circuitry 202 may be further configured to calculate a median of a plurality of interaction scores/points calculated for all the attendees of a particular meeting session (for example a particular classroom). The calculated median (i.e., referred as RAM) may be further added to the interaction score/point of each attendee to calculate a final interaction score for each attendee. This calculation may be performed to normalize a statistical attention curve (i.e. formed by the interaction scores calculated for all the attendees) to reduce any bias in the meeting session as no attendee would be negatively affected because of few high performing attendees/individuals in the meeting session. In an embodiment, the calculation of the final interaction score (i.e. summation of the interaction score of a particular attendee and the calculated median) may be based on the strength of the attendees in the particular meeting session. For example, in case a current strength of the meeting session is less than 30% of the total strength, then the circuitry 202 may not consider the calculated median to calculate the final interaction score. In such case, the final interaction score may be same as the calculated interaction score for each attendee. In another example, in case the current strength of the meeting session is equal to or more than 30% of the total strength, then the circuitry 202 may determine the median (as a RAM value) based on Table 6 mentioned below:

TABLE 6
Exemplary relationship between the position of
interaction score with respect to median and RA_{M} value.

| Position of interaction score of the | RA_{M} |
|---|---|
| Attendee with respect to Median | value |
| Below the Median | 0 |
| Equal to Median | 0.5 |
| Greater than Median | 1.0 |

At 302F, an information determination operation may be performed. In the information determination operation, the circuitry 202 may be configured to determine information associated with the plurality of attendees 116, information associated with a plurality of educators of the plurality of meeting sessions, and information associated with the plurality of meeting sessions. In an embodiment, the circuitry 202 may determine experience information that may be associated with each of the plurality of educators of the corresponding meeting session of the plurality of meeting sessions. The experience information may indicate at least one of: an experience, rating, achievements, or feedbacks related to each educator of the corresponding meeting session. The circuitry 202 may be further configured to store the determined experience information in the memory 204. In some embodiments, the circuitry 202 may retrieve the experience information about a particular educator from the server 110 or from the memory to determine the information about the educator. The experience information of the educator may indicate a competency of the educator to effective present a particular topic or content, and engage the attendees in best possible manner.

The circuitry 202 may be further configured to determine content information associated with content presented during each of the plurality of meeting sessions. The determined content information may indicate, but is not limited to, a type of content (theoretical, interactive, content with practical/logical/real-time examples and exercises, fair for new learners or not), a duration of the content, a subject associated with the content, a complexity of the content, an interactivity of the content, and the like. The circuitry 202 may store the determined content information in the memory 204. In some embodiments, the circuitry 202 may retrieve the content information about particular content from the server 110 or from the memory, to determine the content information associated with the content presented during a particular meeting session.

The circuitry 202 may be further configured to retrieve profile information related to each of the plurality of attendees 116. The profile information may indicate a preference or an interest for a topic or content associated with the corresponding meeting session. In an embodiment, the profile information may further indicate health information associated with the corresponding attendee during a particular meeting session. For example, if the attendee is a student and likes subjects like Mathematics and Science and does not like Social Studies, then the profile information may indicate that the student may be interested in Mathematics and Science but not in Social Studies. Therefore, the attention level of the student may be more while he/she is attending the class of Mathematics and Science as compared to the attention level of the student while he/she is attending a class of Social Studies. Similarly, based on the health information, the system 102 may determine whether the attendee had any specific health problem (like high cold, headache, or fever) while attending the meeting session, which may be a reason for low attentiveness during the meeting session. In some embodiments, the circuitry 202 may retrieve the profile information about a particular attendee from the server 110 or from the memory, to determine the profile information.

The circuitry 202 may be further configured to determine environment information associated with a geo-location of at least one of an educator of each meeting session or of the plurality of attendees 116 of each meeting session. The environment information may indicate weather information associated with the geo-location of at least one of the educators of each meeting session or of the plurality of attendees 116 of each meeting session. The weather (for example heavy rain/wind/storm or excessive hot/cold) of the geo-location may also impact the attention level of the plurality of attendees 116. The environment information may further indicate indoor/outdoor lighting conditions, audibility of the teacher, lighting parameters associated with a device on which the content is being presented, and the like. Similarly, bad lighting conditions or sound problem during the meeting sessions may also affect the attention level of a particular attendee. In some embodiments, the circuitry 202 may receive the environment information about the meeting session, from one or more sensors (like, but not limited to, a temperature sensor, a wind sensor, a rain sensor, a lighting sensor, or an audio sensors) deployed at different places of the meeting session. The circuitry 202 may be further configured to store the determined weather information in the memory 204. In some embodiments, the circuitry 202 may retrieve the environment information about a particular meeting session from the server 110 or from the memory, to determine the environment information.

At 302G, a facial expression determination operation may be performed. In the facial expression determination operation, the circuitry 202 may be configured to determine a facial expression (or emotions) of each of the plurality of attendees 116 during the corresponding meeting sessions based on the received plurality of images 114. In an embodiment, the system 102 may be configured to apply one or more NN models 210 on each of the plurality of images 114 to determine the facial expression of each of the plurality of attendees 116 during the corresponding meeting sessions. The system 102 may be further configured to initialize an expression parameter (E_{N}) with a value for each of the plurality of attendees 116 based on the determined facial expression. To initialize the expression parameter (E_{N}) with the value, the circuitry 202 may be further configured to determine a first facial expression that may be determined for a majority of attendees from the plurality of attendees 116 in a particular meeting session. For example, if a count of the plurality of attendees 116 in the meeting session is “10” and the determined facial expression for “7” number of attendees is a “Smile”, then the first facial expression may be “Smile”. The circuitry 202 may be configured to initialize the expression parameter (E_{N}) for the attendee in the meeting session with the value of ‘1’, if the determined facial expression of the corresponding attendee is same as the first facial expression. Otherwise, the expression parameter (E_{N}) may be initialized with a value of ‘0’. The circuitry 202 may be configured to store initialized value of the expression parameter (E_{N}) for the plurality of attendees 116 in the memory 204. Examples of the facial expression may further include, but are not limited to, happy, sad, emotional, surprise, angry, neutral, amazed, shock, stressed, bored, calm, excited, confused, disgusted, or scared.

At 302H, an object detection operation may be performed. In the object detection operation, the circuitry 202 may be configured to detect one or more objects associated with the plurality of attendees in the received plurality of images 114 for different meeting sessions attended by the corresponding attendees. In another embodiment, the circuitry 202 may be configured to apply one or more neural network (NN) models on the received plurality of images 114 to detect one or more objects associated with the plurality of attendees 116 in the received plurality of images 114. Such objects may be animated objects that may be held by the plurality of attendees 116 or placed near the plurality of attendees 116 in the corresponding meeting sessions. Such objects may include, but is not limited to, a pen, a paper, a notebook (for writing), a water bottle, a toy, a decorative item, an electrical device, a communication device, and the like. The circuitry 202 may be configured to store information about detected one or more objects associated with each of the plurality of attendees 116 in the memory 204. The system 102 may also consider the objects held by the attendees or close to the attendees, as certain objects may distract and reduce the attention level of a particular attendee (such as a toy may distract a young kid, a decorative item/painting may distract an attendee, a personal mobile phone may distract the attendee, and so on).

At 302I, an attention score calculation operation may be performed. In the attention score calculation operation, the circuitry 202 may be configured to calculate an attention score for each of the plurality of attendees 116 for respective meeting session (i.e. based on the activities detected for respective attendee for the corresponding period of time). The attention score may indicate a level of attention of each attendee in the corresponding meeting sessions. The circuitry 202 may be further configured to calculate the attention score of each of the plurality of attendees 116, based on the calculated focus score and the calculated interaction score of the corresponding attendee for respective detected activities in different meeting sessions. By way of example, the calculation of the attention score based on the calculated focus score and the calculated interaction score may be provided by equation (4) as follows:

AS=FS*(1−Z)+IS*Z (4)

where
AS corresponds to attention score,
FS corresponds to the focus score,
IS corresponds to the interaction score, and
Z corresponds to a multiplication factor that may depend on the type of the meeting session and 0<=Z<=1.

In an embodiment, the attendee may not present at his designated/tagged seat (i.e. out of position) in the meeting session, as depicted by timeslot tagged as ‘E’ in the timeline (i.e. indicated in Table 1). In such scenarios, the calculation of the attention score may be provided by equation (5) as follows:

AS=FS*(1−Z)+IS*Z=E (5)

where
AS corresponds to attention score,
FS corresponds to the focus score,
IS corresponds to the interaction score,
Z corresponds to a multiplication factor and 0<=Z<=1, and
E corresponds to an out-of-position score representing that the attendee may not present at the designated seat (i.e., out of position) in the corresponding meeting session.

In an embodiment, the circuitry 202 may be configured to calculate the out-of-position score for a particular attendee based on the strength of the meeting session and the time duration for which the particular attendee is out-of-position from the designated (or identified or tagged) seat. The circuitry 202 may be further configured to calculate a final attention score based on the focus score, the interaction score, and the out-of-position score as per equation (5). For example, in case a current strength of the meeting session is less than 30% of the total strength, then the circuitry 202 may not consider the out-of-position score to calculate the final interaction score. In such case, the final interaction score may be same as the interaction score calculated for each attendee as per equation (4). In another example, in case the current strength of the meeting session is equal to or more than 30% of the total strength, then the out-of-position score (‘E’) may be calculated based on the strength of the meeting session and the time duration of the out-of-position as per Table 7 given below:

TABLE 7
Exemplary relationship between the out-of-position score, number of
attendees (strength), and the time duration for the out-of-position.

| No. of Attendee (A) | Time duration (T) | Out-of-position score (‘E’) |
|---|---|---|
| A > 50% | 60 secs < T < 300 secs | 0 |
| 25% < A < 50% | 60 secs < T < 300 secs | 0.2 |
| A < 25% | 60 secs < T < 300 secs | 0.3 |

For an Attendee A_{IN} (independent of other Attendees)

| | | | |
|---|---|---|---|
| A_{IN} | T <= | 60 secs | 0.5 |
| | T >= | 300 secs | 1.0 |
| | t = | ^{∞} (infinity) | void |

In an embodiment, the circuitry 202 may calculate the interaction score for each attendee for each meeting session attended by the respective attendee. The interaction score for the attendee may be calculated based on the activities detected for the defined period of time (i.e. described, for example, at 302C) in the respective meeting session. Therefore, the disclosed system 102 may calculate a plurality of attention scores for each attendee for different meeting sessions attended by the respective attendee, where one or more meeting sessions of the attendee may be of different meeting categories (i.e. described, for example, at 302A). The plurality of attention scores may indicate an appropriate pattern or variations of attentiveness of a particular candidate in different categories of meeting sessions (i.e. different types, different strengths, different durations, at different ages, different topics/contents, with different experience of educators).

In an embodiment, the circuitry 202 may be configured to calculate the attention score for each of the plurality of attendees 116 based on the calculated focus score, the calculated interaction score of the corresponding attendee and the stored experience information related to the educators of respective meeting sessions. In such case, the calculation of the attention score may be based on the calculated focus score, the calculated interaction score, and the determined experience information and may be performed using equation (6) as follows:

AS=(FS*(1−Z)+IS*Z=E)/(R_{T}+R_{L}) (6)

### Where

AS corresponds to attention score,
FS corresponds to the focus score,
IS corresponds to the interaction score,
Z corresponds to a multiplication factor and 0<=Z<=1, and
E corresponds to a duration for which the attendee may not present at his designated seat,
R_{T} corresponds to the determined experience information; and
R_{L} corresponds to a rating provided by the attendees to the content presented in the corresponding meeting session.

For example, the attendees may be more attentive to higher rated educator and/or content. Therefore, based on division of low attention scores by low educator/content ratings or division of high attention scores by high educator/content ratings may attempt to make the attention scores fair for an inexperienced educator (teachers) or the educator teaching a difficult subject.

In another embodiment, the circuitry 202 may be configured to calculate the attention score based on the calculated focus score, calculated interaction score, and the initialized value of the expression parameter (E_{N}) descried, for example, at 302G. Such calculation of the attention score may be performed by using equation (7) as follows:

AS=FS*(1−Z)+IS*Z+E_{N} (7)

### Where

AS corresponds to the attention score,
FS corresponds to the focus score,
IS corresponds to the interaction score,
Z corresponds to a multiplication factor and 0<=Z<=1, and
E_{N} corresponds to the expression parameter and E_{N}=0 or 1.

In another embodiment, the circuitry 202 may be configured to calculate the attention score based on the profile information related to each of the plurality of attendees 116, the determined environment information (described, for example, at 302F), the calculated focus score, and the calculated interaction score of the corresponding attendee. In another embodiment, the circuitry 202 may be configured to calculate the attention score associated with each of the plurality of attendees 116 based on the calculated focus score, the calculated interaction score, and the detected one or more objects (described, for example, at 302H) associated with the plurality of attendees 116. Therefore, in addition to the consideration of the focus and interactions of the attendees, the disclosed system 102 may consider different influential factors (such as, but are not limited to, the experience information of the educators, the profile information of the attendees, the content information, the environment information, and information about the objects present in the meeting sessions) that may impact the attention score calculated for the attendee for different activities performed during the respective meeting sessions. In an embodiment, the disclosed system 102 may fine tune the attention score (i.e. calculated based on the focus and interaction scores as per equation (4)) using different influential factors for the attentiveness of the attendee (i.e. by using equations (5), (6) and (7)).

At 302J, a ML models training operation may be performed. In the ML models training operation, the circuitry 202 may be configured to train the plurality of ML models 106 for the plurality of attendees 116, based on the calculated attention scores for each of the plurality of attendees 116 and on the meeting categories of the corresponding meeting sessions. Specifically, the circuitry 202 may be configured to train the plurality of ML models 106 for the plurality of attendees 116. Each ML model of the plurality of ML models 106 may be personalized for each attendee. Each personalized ML model may be trained (or store) various attention scores determined from different meeting sessions (of various categories) for the corresponding attendee. Further, with respect to each attention score, the personalized ML model may also be trained on corresponding influential factors (i.e. experience of educator, content, profile of attendee, environmental factors, or nearby objects) identified from different meeting sessions attended in past by the corresponding attendee.

In an embodiment, the personalized ML model may be trained or aware about different positions of seats (i.e. front, back, middle, corner, near window, or near door) at which the particular attendee may be sitting while attending the corresponding meeting session (at least a physical classroom based). The position of the attendee may also impact the attention level/score of the corresponding attendee. For example, a first attendee sitting near the educator may be more attentive than a second attendee who may be seating far away from the educator. Hence the attention score of the first attendee may be more than the attention score of the second attendee. The circuitry 202 may be further configured to train the plurality of ML models 106 for each of the plurality of attendees 116 based on the calculated attention score and the determined position of each of the plurality of attendees 504 in the corresponding meeting session. The association of attendees with different positions (or seats) in the meeting sessions may be referred as seat tagging as described, for example, in FIG. 3 (at 302C).

Thus, the trained ML model for a particular attendee may be aware about different patterns or variations of the attentiveness of the attendee, like at which situation or during which category of meeting session the attention score of the attendee increases or reduces. Further, the personalized ML model may be trained on such cumulative data which indicates a learning journey (at least in form of attentiveness) of a particular attendee (like student) with respect to factors like, subject/topic, class/standard (age group), meeting session type, location of meeting session, seat tagging, information about educator, environmental conditions, or profile of attendees. Each trained model may also indicate behavior characteristics (i.e. actions, gestures, and interactions) of the respective attendee due to training of attention scores of past meeting sessions attended by the respective attendees. Further, the plurality of ML models 106 created by the disclosed system 102 may act as a ranking and rating library of an educational or learning system which may indicate the real-time performance of attendees/educators and provide different recommendations for attendees/educators/content to develop a robust and holistic education or learning system. The plurality of ML models 106 may be further stored in the memory 204 for application in real-time scenarios as described in FIG. 4.

FIG. 4 is diagram that illustrates exemplary operations for meeting session control based on attention determination and application of the ML model trained in FIG. 3 for a particular attendee, in accordance with an embodiment of the disclosure. FIG. 4 is explained in conjunction with elements from FIG. 1, FIG. 2, and FIG. 3. With reference to FIG. 4, there is shown a block diagram 400 that illustrates exemplary operations from 402A to 402F, as described herein. The exemplary operations illustrated in the block diagram 400 may start at 402A and may be performed by any computing system, apparatus, or device, such as by the system 102 of FIG. 1 or the circuitry 202 of FIG. 2. Although illustrated with discrete blocks, the exemplary operations associated with one or more blocks of the block diagram 400 may be divided into additional blocks, combined into fewer blocks, or eliminated, depending on the particular implementation.

At 402A, a data acquisition operation may be performed. In the data acquisition operation, the circuitry 202 may be configured to receive a first set of images 404 of a first attendee 406 of the plurality of attendees 116. The first attendee 406 may be associated with (or attending or attended) a first meeting session. Specifically, the first attendee 406 may be attending the first meeting session that may be different from the plurality of meeting sessions (i.e. based on which a first ML model 402 may be trained for the first attendee, as described, for example in FIG. 3). As discussed above, the plurality of ML models 106 for the plurality of attendees 116 may be trained based on data (i.e. attention scores, or activities related to actions/gestures/interactions) associated with the plurality of meeting sessions and may not be trained on data associated with the first meeting session. In an embodiment, the first set of images 404 may be of multiple attendees (including the first attendee) who have attended (or currently attending) the first meeting session. The circuitry 202 of the system 102 may receive the first set of images 404 from the server 110 or directly from one or more image capture devices located at different places of the first meeting session. In case, the first meeting session is an online meeting session, then one or more image capture devices may be integrated on electronic devices (like laptop, computer, or mobile phone) used by the attendees to attend the first meeting session.

In another embodiment, the circuitry 202 may be further configured to control the audio capture device 108 (i.e. installed at the first meeting session close to each attendee) to capture an interaction 408 between the first attendee 406 and an educator of the first meeting session. In an embodiment, the captured interaction 408 may be associated with content presented in the first meeting session or related to a query raised by the educator (or by the first attendee 406) or related to a response provided by the first attendee 406 (or by the educator). For example, the first attendee may be asking one or more questions related to the content and the educator may be providing a response to the first attendee 406 for the asked one or more questions or vice-versa.

In another embodiment, the circuitry 202 may be configured to determine experience information associated with each educator of the first meeting session. The experience information may indicate at least one of an experience, rating, achievements, or feedbacks related to each educator of the first meeting session. The circuitry 202 may be further configured to determine content information associated with content presented during the first meeting session. The circuitry 202 may be further configured to retrieve profile information related to the first attendee or other attendees in the first meeting session. The profile information may indicate a preference or an interest of the first attendee 406 for a topic or the content presented or discussed in the first meeting session. In another embodiment, the circuitry 202 may be further configured to determine environment information associated with a geo-location of at least one of an educator of the first meeting session or the first attendee. Details about the experience information, the content information, the profile information, and the environment information, are provided, for example, at 302F in FIG. 3.

At 402B, an activities detection operation may be performed. In the activities detection operation, the circuitry 202 may be configured to detect a first set of activities that may performed by the first attendee 406 during the first meeting session. The first set of activities may be detected based on the application of one or more NN models 210 on the received first set of images 404. The first set of activities may be detected over a first period of time (for example of certain seconds or minutes) of the first meeting session. For example, the first set of activities of the first attendee 406 may be detected for “10” minutes in between the first meeting session. Details about the detection of the first set of activities are provided, for example, at 302C of FIG. 3. The first set of activities of the first attendee 406 may be associated with at least one of an action performed by the first attendee 406, the gesture performed by the first attendee 406, the head pose of the first attendee 406, the body posture of the first attendee 406, the lip movement of the first attendee 406, the gaze of the first attendee 406, or the facial emotion of the first attendee 406 as described, for example, at 302C of FIG. 3. In an embodiment, the circuitry 202 may generate a three-dimensional (3D) map of the corresponding first meeting session including the first attendee based on the received first set of images 404 (as described, for example, at 302B in FIG. 3). The circuitry 202 may further apply one or more NN models 210 on the generated three-dimensional (3D) map of the first meeting session to detect the first set of activities of the first attendee 406.

At 402C, an interaction duration determination operation may be performed. In the interaction duration determination operation, the circuitry 202 may be configured to determine a second duration (for example in seconds or minutes) of the captured interaction 408 between the first attendee 406 and an educator of the first meeting session. The circuitry 202 may be further configured to compare the determined second duration with a threshold duration. In case the determined second duration is less than the threshold duration, the control may be transferred to 402E. In other words, in such case, the circuitry 202 may discard the captured interaction 408. For example, if the threshold duration is 5-10 seconds (i.e. minimum response time for a query) and the captured interaction 408 is of lesser seconds, (like 2 seconds), then the circuitry 202 may ignore the captured interaction 408, as the captured interaction 408 may be of lesser duration which may not be considered as a proper response to measure the attentiveness of the attendee or may not indicate an appropriate quality of response for asked query. Otherwise the control may be transferred to 402D.

In an embodiment, the circuitry 202 may compare the determined second duration with the threshold duration to determine the relevancy of the captured interaction 408 with the content presented in the first meeting session. For example, if the one or more questions asked by the first attendee is not relevant to the content, the educator may simply ignore the asked one or more questions or provide shorter responses like “This is not relevant” or “This has been taught already” and the like. Hence, in such cases, the captured second duration may be short and possibly less than the threshold duration. In other case, if the one or more questions asked by the first attendee is relevant to the content, the educator may provide detailed answers and hence, the captured second duration may be greater than the threshold duration. The relevant questions asked by the attendee or relevant answers provided by the attendee may also indicate the attentiveness of the attendee to a certain extent.

In an embodiment, the circuitry 202 may be further configured to utilize voice recognition techniques to identify voice of the first attendee 406 and the educator in the captured interaction 408. The detailed implementation of the aforementioned voice recognition techniques may be known to one skilled in the art, and therefore, a detailed description for the aforementioned voice recognition techniques has been omitted from the disclosure for the sake of brevity. In another embodiment, the circuitry 202 may be further configured to determine a sequence of communication and an amplitude of the communication in the captured interaction 408 between the first attendee 406 and the educator. Based on the determination of the sequence and the amplitude of the communication, the system 102 may be configured to determine whether the capture interaction 408 of the first attendee 406 is with the educator or with another attendee present in the first meeting session.

At 402D, a keyword determination operation may be performed. In the keyword determination operation, the circuitry 202 may be configured to determine one or more keywords in the captured interaction 408. In an embodiment, the circuitry 202 may be configured to apply one or more NN models 210 on the captured interaction 408 to determine one or more keywords. In another embodiment, the circuitry 202 may be configured to generate a transcription of the captured interaction 408 and further determine the one or more keywords in the captured interaction 408. In such scenarios, one or more NN models 210 may include at least one natural language processing (NLP) model that may be trained to determine one or more keywords in the captured interaction 408. The determined one or more keywords may be relevant to the content presented in the first meeting session. The circuitry 202 may be configured to analyze the determined keywords in the captured interaction 408, to determine whether the keywords are related to the topic of the presented content or related to the raised queries or not. Based on such analysis and the determination, the circuitry 202 may determine the attentiveness of the first attendee 406 during the first meeting session.

At 402E, an attention score calculation operation may be performed. In the attention score calculation operation, the circuitry 202 may be configured to calculate a first attention score associated with the first attendee 406. The first attention score may indicate a level of attention of the first attendee 406 in the first meeting session and may be calculated for the first period of time based on the detected first set of activities. To calculate the attention score, the system 102 may be configured to calculate a first action score and a first interaction score of the first attendee 406 based on the detected first set of activities. The circuitry 202 may be further configured to calculate the first attention score based on the calculated first action score and the calculated first interaction score. In another embodiment, the circuitry 202 may be configured to determine a first facial expression of the first attendee 406 and further calculate the first attention score based on the determined first facial expression. Details about the calculation of the attention core (similar to the first attention score) are provided, for example, at 302I in FIG. 3.

In an embodiment, the circuitry 202 may calculate the first attention score further based on the detected first set of activities, determined second duration, and the determined one or more keywords in the captured interaction 408. In another embodiment, the first attention score may be calculated based on the experience information, the content information, the profile information, and the environment information. In an embodiment, the circuitry 202 may be configured to calculate the first focus score and the first interaction score associated with the first attendee 406 based on the detected first set of activities and/or the determined second duration and/or the determined one or more keywords and/or the experience information, and/or the content information, and/or profile information, and/or the environment information, and/or the determined first facial expression. Based on the calculated first focus score and the calculated first interaction score, the circuitry 202 may be configured to calculate the first attention score. Details about the calculation of the first attention score are provided, for example, in FIG. 3.

At 402F, a trained ML model application operation may be performed. In the trained ML model application operation, the circuitry 202 may be configured to apply the first ML model 402 on the calculated first attention score. Specifically, the circuitry 202 may be configured to apply the first ML model 402 of the plurality of ML models 106 (that may be trained at 302J in FIG. 3), on the calculated first attention score. The plurality of ML models 106 may be trained on a plurality of attention scores of the plurality of attendees 116 related to a plurality of meeting sessions of different meeting categories as described, for example, in FIG. 3. The system 102 may store the plurality of ML models 106 in the memory 204. The plurality of meeting sessions may be attended in past by the plurality of attendees 116 based on which the plurality of ML models 106 are trained.

In an embodiment, the circuitry 202 may apply the first ML model 402 on the calculated first attention score and on the meeting category of the first meeting session which the first attendee 406 may have attended or currently attending. The first ML model 402 may be already trained on data associated with the first attendee 406 only and therefore, the first ML model 402 may be personalized for the first attendee. The first ML model 402 may be trained on historical cumulative data (i.e. set of historical attention scores of the first attendee 406 calculated for different meeting sessions attended in past as described, for example, at 302J in FIG. 3). In an embodiment, the circuitry 202 may be configured to compare the calculated first attention score with a first threshold attention score. The first threshold attention score may be a minimum attention score associated with the first attendee 406 and may be determined based on the set of historical attention scores that may be associated with the first attendee 406. In case, the calculated first attention score is less than the first threshold attention score, the control may be transferred to 402G. Otherwise, the control may be transferred to end.

Based on the set of historical attention scores (on which the first ML model 402 is trained), the circuitry 202 may determine when the attention of the first attendee 406 drops significantly (i.e. as indicated by the calculated first attention score of the first attendee 406 while attending the first meeting session). In other words, based on the first ML model 402 (i.e. trained on the set of historical attention scores of the first attendee 406 and different meeting categories), the circuitry 202 may determine or predict when the calculated first attention score of the first attendee 406 (i.e. attending the first meeting session of a particular category) drops. For example, the training data of the first ML model 402 indicates that the historical attention scores of the first attendee 406 are low for certain meeting sessions (like for online sessions without educator, high strength meeting sessions, when duration of the meeting session exceeds one hour, when the attendee sits at back positions, or content is theoretical). In such case, if the first meeting session is of a particular category, which may be trained in the first ML model 402 with low attention scores, then the circuitry 202 may upfront predict that the first attention score of the first attendee 406 while attending the first meeting session may drop and an appropriate action or recommendation may be required to increase the first attention score of the first attendee 406 during the remaining time of the first meeting session.

At 402G, a recommendations determination operation may be performed. In the recommendations determination operation, the circuitry 202 may be configured to determine a first set of recommendations. The first set of recommendations may be associated with at least one of the first attendee 406, an educator of the first meeting session, or first content that may be presented in the first meeting session. The circuitry 202 may determine the first set of recommendations based on the application of the first ML model 402 on the calculated first attention score and on the meeting category of the first meeting session. In an embodiment, the circuitry 202 may determine the first set of recommendations, based on the determination or prediction (using the trained first ML model 402) that the first attention score for the first attendee 406 may drop (i.e. will come below the first threshold attention score) in the first meeting session with respect to the meeting category of the first meeting session. For example, if the first meeting session includes theoretical content, of long duration, and taken by a low rating educator, then the first attention score may be low or may drop after certain time period. Therefore, to further avoid the drop of the first attention score, the circuitry 202 may determine the first set of recommendations either for the first attendee 406, for the educator of the first meeting session, or for the content presented in the first meeting session. The first set of recommendations, if followed, may increase the attention score of the first attendee 406 in a remaining portion of the first meeting session.

The determined first set of recommendations may include at least one of a first recommendation associated with the first attendee 406, a second recommendation associated with the educator of the first meeting session, or a third recommendation associated with content presented in the first meeting session. For example, the first recommendation associated with the first attendee 406 may include, but are not limited to, one or more individual performance reports with detailed analysis of attention level breakdown across content and educators, one or more focus/improvement areas, a recommended seating position in the meeting session, a recommendation to get an energy drink (like coffee) or a break, an appropriate content or an educator based on an interest of the attendee, and the like. The second recommendation associated with the educator of the meeting session may include, but are not limited to, a modification of the content (for example adding practical or real-time example), a suggestion (i.e. weblink) to similar content with high-rating or number of shares/likes, a modification of delivery of the content, an alert to the educator on significant attention level changes of the first attendee 406, a suggestion to take a break or a pause in the first meeting session, a suggestion to update the duration of the meeting session due to the content, a suggestion to change the time of session due to environmental conditions, ways to improve environmental conditions (like to improve lighting or sound conditions), a suggestion to refer certain certifications, a suggestion to increase teaching capability or ratings, and the like. The third recommendation associated with content presented in the first meeting session may include, but are not limited to, a modification of the content to add other type of content (such as self-explanatory content), a modification of the content to add interactive content (like pictures, videos, or diagrams), a modification of the content to remove redundant content, a modification of the content to remove complex content, a modification of the content to add one or more practical sessions to current theoretical content, and the like.

In some embodiments, the first set of recommendations may act as one or more feedbacks (like 360-degree feedbacks) for a particular attendee or for a particular educator. In another embodiment, the one or more feedbacks may be a two-way feedback between the educator and the particular attendee. In certain embodiments, the recommendation may be determined for an authority (such as a management/administration committee of an educational institution, an education board, or a principal of a school/college, and the like) to take certain decisions (like, but not limited to, change the educator with higher rating or experience, change the content, add certain practical sessions in the curriculum, shorten the duration of certain sessions, add in-between breaks of the meeting session, add certain educational counsellors in the teaching staff, update overall educational plan, update physical conditions or logistics in the meeting sessions, and the like).

At 402H, an output operation may be performed. In the output operation, the circuitry 202 may be configured to output the determined first set of recommendations. For example, the system 102 may control the display device 206A to render the first set of recommendations for the first attendee 406 or for the educator. In some embodiments, as the output, the circuitry 202 may generate a notification for the first attendee 406 or for the educator of the first meeting session, based on the application of the first ML model 402 on the calculated first attention score and the meeting category of the first meeting session. The generated notification may include at least one of the first set of recommendations. The notification may be an upfront alert that may be provided to the first attendee 406 or to the educator of the first meeting session based on the determination or prediction of low attention score of the first attendee 406 in the first meeting session. The low attention score of the first attendee 406 may be predicted based on the application of the first ML model 402 (i.e. personalized model trained for the first attendee 406) on the meeting category of the first meeting session and on the attention scores (i.e. the first attention score) calculated during the first meeting session for one or more activities (i.e. actions, gestures, interactions, and other factors) performed by the first attendee 406. The upfront notification may timely alert the educator or the first attendee 406 to take appropriate actions (like the first set of recommendations) to avoid further reduction in the first attention score or to increase the first attention score of the first attendee 406 for remaining duration of the first meeting session. The first set of recommendations provided to the attendee or to the educator, may further enhance a learning journey of the attendee. The circuitry 202 may further transmit the generated notification to an electronic device that may be associated with the first attendee 406 or the educator of the first meeting session. The electronic device may include suitable logic, circuitry, and interfaces that may be configured to receive the notification from the system 102. The electronic device may be further configured to render the received notification. Examples of the electronic device may include, but are not limited to, a cellular phone, a mobile phone, a computing device, a smartphone, a gaming device, a mainframe machine, a server, a computer workstation, and/or a consumer electronic (CE) device. Therefore, based on the real-time assessment of the attention score of the attendee and using the trained personalized ML model for the attendee, the disclosed system 102 may effectively control the meeting session using the output of the determined recommendations, to further enhance the learning journey of the attendee.

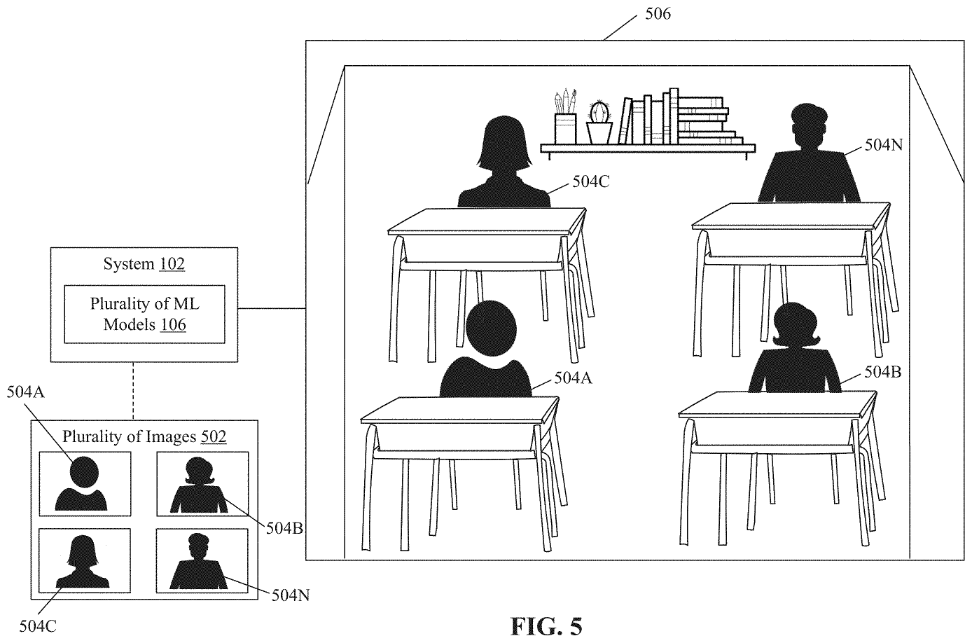

FIG. 5 is a diagram that illustrates an exemplary scenario for generation of a simulated view for the plurality of attendees related to a meeting session, in accordance with an embodiment of the disclosure. FIG. 5 is explained in conjunction with elements from FIG. 1, FIG. 2, FIG. 3, and FIG. 4. With reference to FIGS. 5, there is shown a first diagram. With reference to FIG. 5, there is shown the system 102 that may include the plurality of ML models 106. There is further shown a plurality of images 502 of a plurality of attendees 504A-504N that may be attending a particular meeting session.

The system 102 may control the plurality of image capture devices 104 (as shown in FIG. 1) to capture the plurality of images 502 of the plurality of attendees 504A-504N. The plurality of attendees 504A-504N may include a first attendee 504A, a second attendee 504B, a third attendee 504C, and an Nth attendee 504N. In case, the meeting session is being held in a physical location, then the plurality of image capture devices 104 may include CCTV cameras that may be installed at certain positions within the physical space. In case, the meeting session is being held virtually (i.e. in online mode), then the plurality of image capture devices 104 may include at least one web camera associated with an electronic device from which the plurality of attendees 504A-504N may be attending the meeting session.

The system 102 may receive the plurality of images 502 of the plurality of attendees 504A-504N from the plurality of image capture devices 104. Based on the reception of the plurality of images 502, the system 102 may be configured to identify each of the plurality of attendees 504A-504N. In an embodiment, the system 102 may be configured to apply facial recognition techniques using one or more NN models 210 on each of the plurality of images 502 to identify each of the plurality of attendees 504A-504N. The detailed implementation of the aforementioned facial recognition techniques may be known to one skilled in the art, and therefore, a detailed description for the aforementioned facial recognition techniques has been omitted from the disclosure for the sake of brevity.

In case the meeting session is being held in the physical location (like a physical classroom, the system 102 may be configured to determine a position of each of the plurality of attendees 504A-504N in the corresponding meeting session based on the received plurality of images 502 (or based on the generated 3D map of the meeting session as described, for example, at 302B in FIG. 3). In an embodiment, the circuitry 202 of the system 102 may be configured to determine the position of each of the plurality of attendees 504A-504N in the corresponding meeting session based on the captured depth information/the plurality of depth values. The determined position, the 3D map of the meeting session, and the facial recognition of the attendee may allow the circuitry 202 to tag or associate a particular attendee with a physical seat (like at back, front, middle, or near window/door) in the meeting session at which the attendee may be sitting while attending the meeting session.

In case the meeting session is being held virtually (i.e. such as web-conference or online session held over the internet), the system 102 may be configured to generate a simulated view 506 of the corresponding meeting session. In the generated simulated view 506, each of the plurality of attendees 504A-504N may be visualized as seated next to each other (similar to what happens in a physical classroom session). The generated simulated view 506 may be a computer-generated environment with scenes and objects that appear to be real, making each of the plurality of attendees 504A-504N feels as they are immersed in the physical meeting session and surroundings. In other words, the generated simulated view 506 may mimic a single comprehensive view of the meeting session to each of the plurality of attendees 504A-504N. In some embodiments, the circuitry 202 may determine certain online action (like online hand raising) performed by the first attendee 406 during an online meeting session, and further convert the online action into a representation for similar physical action (like physical hand raising). The circuitry 202 may further superimpose the representation over the corresponding attendee visualized in the simulated view 506.

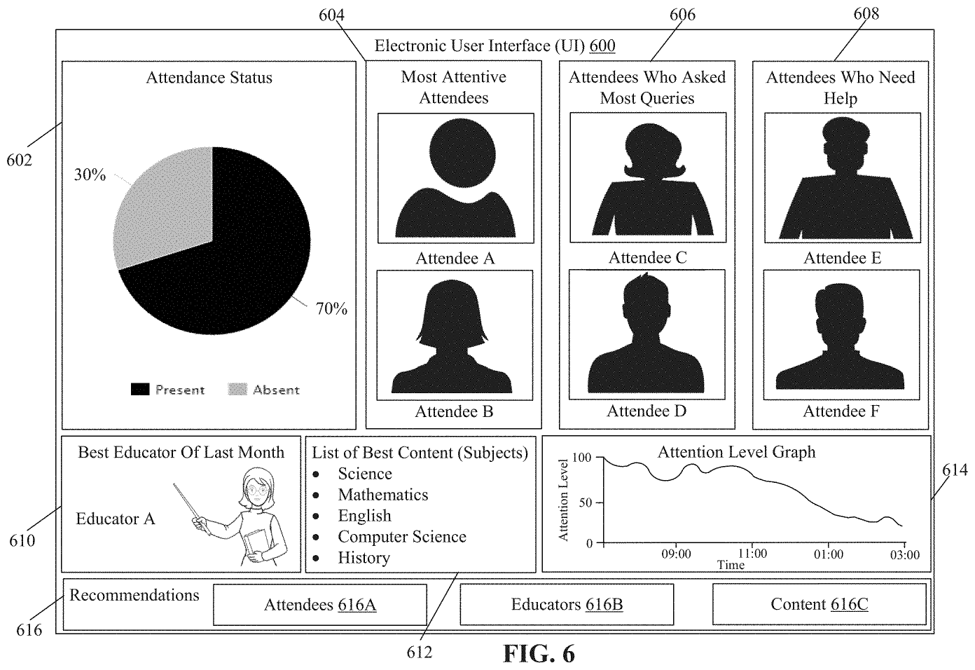

FIG. 6 is a diagram that illustrates an exemplary user interface for rendering of dashboard information, in accordance with an embodiment of the disclosure. FIG. 6 is explained in conjunction with elements from FIG. 1, FIG. 2, FIG. 3, FIG. 4, and FIG. 5. With reference to FIG. 6, there is shown an electronic UI 600. The electronic UI 600 may be displayed on the display device 206A of the system 102 or may be displayed on an electronic device associated with the educator or at least one of the plurality of attendees 116 based on reception of a first user input. The first user input may be received via an application interface displayed onto a display screen of the display device 206A or onto a display screen of electronic device associated with the educator or the attendee. The application interface may be part of an application software, for example, a software development kit (SDK), a cloud server-based application, a web-based application, an OS-based application/application suite, an enterprise application, a mobile application.

In an embodiment, the system 102 may be configured to generate dashboard information. The generated dashboard information may be associated with the first attendee 406 of the plurality of attendees 116 and may be generated based on the calculated attention scores for a set of meeting sessions that may be attended by the first attendee 406. The generated dashboard may include one or more statistics at least for the set of meeting sessions. The circuitry 202 may be further configured to render the generated dashboard information on the electronic UI 600. In some embodiments, the dashboard information may be generated for the plurality of meeting sessions attended by a particular attendee or by the plurality of attendees 116, say in last certain weeks, months, or years.

On the electronic UI 600, for example, there is shown a set of UI elements, such as a first UI element 602, a second UI element 604, a third UI element 606, a fourth UI element 608, a fifth UI element 610, a sixth UI element 612, a seventh UI element 614, and an eight UI element. The first UI element 602 may be labelled as “Attendance Status” and may indicate a percentage of presence and absence of the plurality of attendees 116 in a first meeting session of the set of meeting sessions. In an example, “Attendance Status” may indicate the presence/absence percentages of the first attendee 406 who attended the set of meeting sessions in past. The second UI element 604 may be labelled as “Most Attentive Attendees” and may indicate at least one attendee whose attention scores may be maximum among the plurality of attendees 116 who attended the set of meeting sessions. The third UI element 606 may be labelled as “Attendees Who Asked Most Queries” and may indicate at least one attendee who may have asked a maximum number of queries in the set of meeting sessions. The attendee who asked higher number of questions may be determined based on the activities and interactions performed by the attendee in past meeting sessions as described, for example, in FIG. 3. The fourth UI element 608 may be labelled as “Attendees who Need Help” and may indicate at least one attendee whose attention score may be minimum among the plurality of attendees 116 who attended the set of meeting sessions. Different set of recommendations may be suggested to such attendee by the disclosed system 102 as described, for example, at 402G in FIG. 4. In an embodiment, the disclosed system 102 may also suggest awards or recognitions for the “Most Attentive Attendees” or for the “Attendees Who Asked Most Queries” from the educator of the meeting session. This may be done to provide a feeling of gamification among the plurality of attendees in the meeting session and further enhance the attention score of each attendee in the meeting session.

The fifth UI element 610 may be labelled as “Best Educator of Last Month” and may indicate at least one educator present in past meeting sessions (for example happened in last one month), where the higher number of attendees achieved good attention scores (or above a specific attention score threshold). The sixth UI element 612 may be labelled as “List of Best Content (Subjects)” and may indicate at least one content for which the first attendee 406 (or the maximum count of attendees) may be more attentive (i.e. may have high level of attention scores). The seventh UI element 614 may be labelled as “Attention Level Graph” and may indicate a graph (or statistics) between the attention levels of the first attendee 406 and time for at least one meeting session of the set of meeting sessions. For example, the graph indicates a drop in the attention scores of a particular attendee based on increase in time (or progress) of a particular meeting session. As another example, the statistics may indicate the pattern or variations of the attention scores for different attendees based on different factors related to meeting sessions, such as category of meeting session, durations of meeting session, educators, content, seating positions, environmental conditions, and the like. Such graphs in the dashboard information about the particular attendee may further alert and/or encourages the attendee to effectively follow the recommendations to increase the attentions scores and to enhance their learning performance and related achievements. Further, different statistics in the dashboard information (like most attentive attendee) may encourage competitiveness among the attendees of the meeting session, which may further enhance the attention scores and leaning performance of different attendees.

As an example, and with reference to FIG. 6, 70% of the attendees of the plurality of attendees 116 may be present in the first meeting session of the set of meeting sessions, whereas 30% of the attendees of the plurality of attendees 116 may be absent in the first meeting session. Attendee “A” and Attendee “B” may have maximum attention score among the plurality of attendees 116. Attendee “C” and Attendee “D” may have asked maximum number of queries in the set of meeting sessions. Attendee “E” and Attendee “F” may have minimum attention score among the plurality of attendees 116. Educator “A” may be the best educator of the previous month and the list of best content (Subjects) may include Science, Mathematics, English, Computer Science, and History.

In another embodiment, the generated dashboard information may include more statistics that may be associated with the educator, the plurality of attendees 116, or the content presented in the corresponding meeting session. The generated dashboard information may also include other statistics based on various parameters like content, grades, and years. In an embodiment, the generated dashboard information may be presented in the meeting session (say in a classroom) to promote a healthy competition among the plurality of attendees 116. The generated dashboard information may be further used to evaluate a performance of the first attendee 406 and to further determine strengths and weakness of the first attendee. As shown in FIG. 6, the dashboard information may depict different set of recommendations 616 including recommendation for attendees (i.e. Attendees 616A), recommendations for educators (i.e. Educators 616B) and recommendations for presented content (i.e. Content 616C) as described, for example, at 402G in FIG. 4. The generated dashboard information may also be used by different educational authorities (or educators) to take appropriate decisions (like follow recommendations) to effectively increase the attention scores and enhance overall learning journey of an attendee. In some embodiments, the circuitry 202 may determine the attention scores for not only for a particular attendee, but may be for a set of attendees located at a particular position in the meeting session. For example, the circuitry 202 may determine the attention scores for the set of attendees sitting in a particular row (like front row, back row) of the meeting session. Based on requests received from an attendee, educator, or any educational/professional authority, the circuitry 202 may control output of information about the attention scores (i.e. determined for the set of attendees) as the dashboard information. Similarly, the dashboard information may indicate different information about the attention scores in several manners, such as (but is not limited to) column-wise, row-wise, section-wise, age-wise, localized area-wise, educator-wise, year-wise, designation-wise, and the like. Thus, the dashboard information, generated by the disclosed system 102, acts as a real-time attention level meter of a particular meeting session (for example an ongoing class) which may render real-time attention scores of different attendees, and further alert (using different user interfaces options like highlighting, or in other formats) the educators about the attendees with rising or falling attentions. Therefore, the dashboard information may provide real-time visualization of one or more statistics at least for the set of meeting sessions in terms of gamification charts. Similarly, the generated dashboard information by the disclosed system 102 may indicate for which particular factor (like a particular row/column/hotspot-area, educator, content, type of meeting session, duration of sessions, subject/topic, etc.), the attentiveness of the attendees is better or has to be improved using real-time output of appropriate recommendations. The hot-spot area in the meeting session may correspond to an area where the attention score of each attendee, within the area, may be less than a threshold attention score or may be higher than the threshold attention score.

In another embodiment, the disclosed system 102 may be capable to identify one or more malpractices that may be done by the first attendee 406 in the first meeting session. The one or more malpractices may include, but are not limited to, cheating, talking to other attendees, illegal aiding of attendees by the educator (for example during examination), use of an unauthorized material in the examination hall, a usage of illegal and abusing gestures by an attendee, a physical assault performed, and the like. In such scenarios, the circuitry 202 may be configured to determine a pattern in the detected first set of activities performed by as attendee (such as the first attendee 406). Based on the determined pattern in the first set of activities, the circuitry 202 may be configured to detect one or more malpractices during the first meeting session based on the determined pattern. In an embodiment, the circuitry 202 may be configured to apply at least one of the plurality of ML models or one or more NN models 210 on the detected first set of activities to detect the malpractice. Based on the detected malpractice, the system 102 may be configured to generate a first notification for the first attendee 406 or for the educator of the first meeting session. In some embodiments, the system 102 may store information about the detected malpractice in the memory 204 for future reference (like for internal/external investigations or to take appropriate actions to avoid such malpractices).

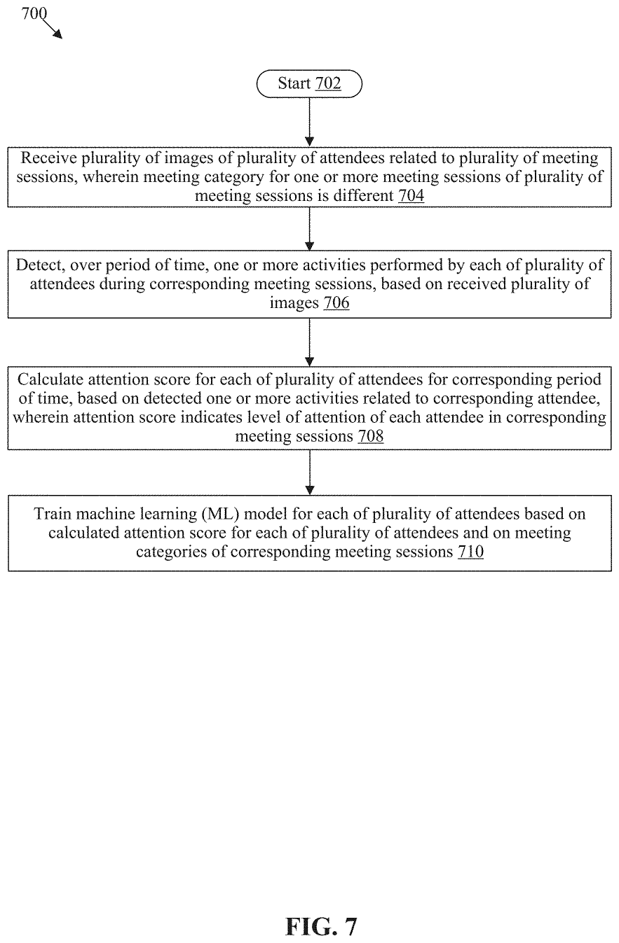

FIG. 7 is a flowchart that illustrates exemplary operations for training a ML model for meeting session control based on attention determination, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a flowchart 700. The operations from 702 to 710 may be implemented on any computing device, for example, the system 102 or the circuitry 202. The operations may start at 702 and proceed to 704.

At 704, the plurality of images 114 of the plurality of attendees 116 related to a plurality of meeting sessions may be received, wherein the meeting category for the one or more meeting sessions of the plurality of meeting sessions may be different. In one or more embodiments, the circuitry 202 may be configured to receive the plurality of images 114 of the plurality of attendees 116 related to the plurality of meeting sessions, wherein the meeting category for the one or more meeting sessions of the plurality of meeting sessions may be different. The details about the reception of the plurality of images 114 are provided for example, in FIGS. 1, 3 (at 302A), and 4 (at 402A).

At 706, the one or more activities performed by each of the plurality of attendees during the corresponding meeting sessions may be detected over a period of time based on the received plurality of images 114. In one or more embodiments, the circuitry 202 may be configured to detect, over the period of time, the one or more activities performed by each of the plurality of attendees 116 during the corresponding meeting sessions, based on the received plurality of images 114. The details about the detection of the one or more activities are provided, for example, in FIGS. 1, 3 (at 302C), and 4 (at 402B).

At 708, the attention score, for each of the plurality of attendees 116 for the corresponding period of time may be calculated, based on the detected one or more activities related to the corresponding attendee, wherein the attention score indicates the level of attention of each attendee in the corresponding meeting sessions. In one or more embodiments, the circuitry 202 may be configured to calculate the attention score for each of the plurality of attendees 116 for the corresponding period of time, based on the detected one or more activities related to the corresponding attendee, wherein the attention score indicates the level of attention of each attendee in the corresponding meeting sessions. The details about the calculation of the attention score are provided, for example, in FIG. 3 (at 302I).

At 710, the ML model for each of the plurality of attendees may be trained based on the calculated attention score for each of the plurality of attendees 116 and on the meeting categories of the corresponding meeting sessions. In one or more embodiments, the circuitry 202 may be configured to train the ML model for each of the plurality of attendees 116 based on the calculated attention score for each of the plurality of attendees and on the meeting categories of the corresponding meeting sessions. Details about the training of the plurality of ML models 106 for the plurality of attendees 116 are provided, for example, in FIGS. 1 and 3 (at 302J). Control may pass to end.

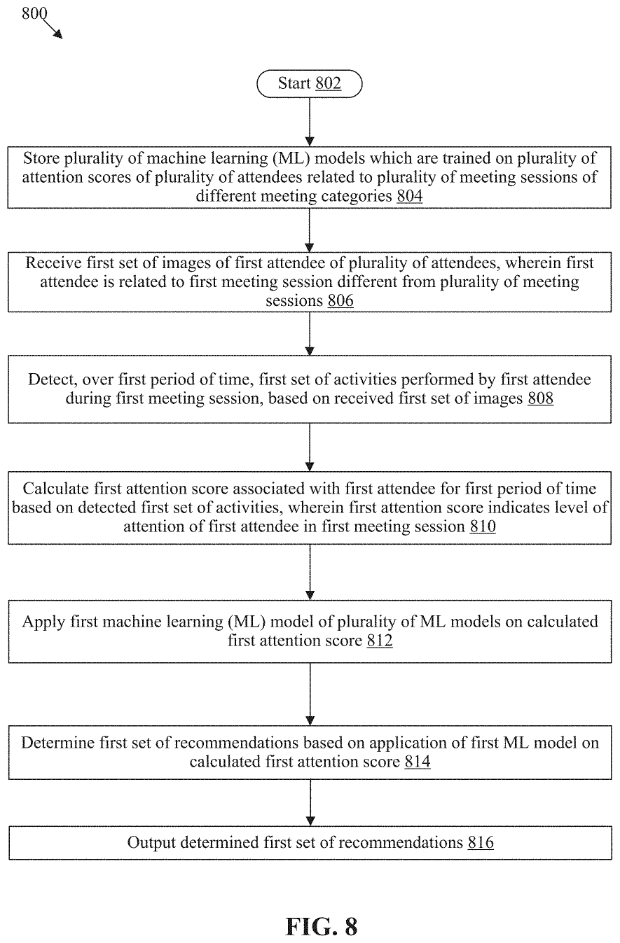

FIG. 8 is a flowchart that illustrates exemplary operations for meeting session control based on attention determination and application of the ML model for a particular attendee, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown a flowchart 800. The operations from 802 to 816 may be implemented on any computing device, for example, the system 102 or the circuitry 202. The operations may start at 802 and proceed to 804.

At 804, the plurality of ML models 106, that may be trained on the plurality of attention scores of the plurality of attendees related to the plurality of meeting sessions of different meeting categories, may be stored. In one or more embodiments, the circuitry 202 may be configured to store the plurality of machine learning (ML) models which may be trained on the plurality of attention scores of the plurality of attendees 116 related to the plurality of meeting sessions of different meeting categories.

At 806, the first set of images 404 of the first attendee 406 of the plurality of attendees 116 may be received, wherein the first attendee is related to a first meeting session different from the plurality of meeting sessions. In one or more embodiments, the circuitry 202 may be configured to receive the first set of images 404 of the first attendee 406 of the plurality of attendees 116, wherein the first attendee 406 is related to a first meeting session different from the plurality of meeting sessions as described, for example, in FIG. 4 (at 402A).

At 808, the first set of activities performed by the first attendee 406 during the first meeting session may be detected over a first period of time based on the received first set of images 404. In one or more embodiments, the circuitry 202 may be configured to detect, over the first period of time, the first set of activities performed by the first attendee 406 during the first meeting session, based on the received first set of images 404 as described, for example, in FIG. 4 (at 402B).

At 810, the first attention score associated with the first attendee 406 may be calculated for the first period of time based on the detected first set of activities, wherein the first attention score indicates the level of attention of the first attendee 406 in the first meeting session. In one or more embodiments, the circuitry 202 may be configured to calculate the first attention score associated with the first attendee 406 for the first period of time based on the detected first set of activities, wherein the first attention score indicates the level of attention of the first attendee 406 in the first meeting session as described, for example, in FIG. 4 (at 402B).

At 812, the first machine learning (ML) model 402 of the plurality of ML models 106 may be applied on the calculated first attention score. In one or more embodiments, the circuitry 202 may be configured to apply the first machine learning (ML) model 402 of the plurality of ML models 106 on the calculated first attention score as described, for example, in FIG. 4 (at 402F).

At 814, a first set of recommendations may be determined based on the application of the first ML model 402 on the calculated first attention score. In one or more embodiments, the circuitry 202 may be configured to determine the first set of recommendations based on the application of the first ML model 402 on the calculated first attention score as described, for example, in FIG. 4 (at 402G).

At 816, the determined first set of recommendations may be outputted. In one or more embodiments, the circuitry 202 may be configured to output the determined first set of recommendations as described, for example, in FIG. 4 (at 402H). Control may pass to end.

Various embodiments of the disclosure may provide a non-transitory computer-readable medium and/or storage medium having stored thereon, computer-executable instructions executable by a machine and/or a computer such as the system 102. The computer-executable instructions may cause the machine and/or computer to perform operations that may include reception of a plurality of images (such as the plurality of images 114) of a plurality of attendees (such as the plurality of attendees 116) related to a plurality of meeting sessions. A meeting category for one or more meeting sessions of the plurality of meeting sessions may be different. The operations may further include detection, over a period of time, of one or more activities that may be performed by each of the plurality of attendees 116 during the corresponding meeting sessions, based on the received plurality of images 114. The operations may further include calculation of an attention score for each of the plurality of attendees 116 for the corresponding period of time, based on the detected one or more activities related to the corresponding attendee. The attention score may indicate a level of attention of each attendee in the corresponding meeting sessions. The operations may further include training of a machine learning (ML) model (such as the first ML model 402) for each of the plurality of attendees 116 based on the calculated attention score for each of the plurality of attendees 116 and on the meeting categories of the corresponding meeting sessions.

Various embodiments of the disclosure may provide a non-transitory computer-readable medium and/or storage medium having stored thereon, computer-executable instructions executable by a machine and/or a computer such as the system 102. The computer-executable instructions may cause the machine and/or computer to perform operations that may include storage of a plurality of machine learning (ML) models (such as the plurality of ML models 106) which may be trained on a plurality of attention scores of a plurality of attendees related to a plurality of meeting sessions of different meeting categories. The operations may further include reception of a first set of images (such as the first set of images 404) of a first attendee (such as the first attendee 406) of the plurality of attendees. The first attendee 406 may be related to a first meeting session that may be different from the plurality of meeting sessions. The operations may further include detection, over a first period of time, of a first set of activities that may be performed by the first attendee 406 during the first meeting session, based on the received first set of images 404. The operations may further include calculation of a first attention score that may be associated with the first attendee 406 for the first period of time based on the detected first set of activities. The first attention score may indicate the level of attention of the first attendee 406 in the first meeting session. The operations may further include application of the first machine learning (ML) model 402 of the plurality of ML models 106 on the calculated first attention score. The operations may further include determination of a first set of recommendations based on the application of the first ML model 402 on the calculated first attention score. The operations may further include output of the determined first set of recommendations.

Exemplary aspects of the disclosure may include a system (such as the system 102 of FIG. 1) that may include circuitry (such as the circuitry 202). The circuitry may be configured to receive a plurality of images (such as the plurality of images 114) of a plurality of attendees (such as the plurality of attendees 116) related to a plurality of meeting sessions. A meeting category for one or more meeting sessions of the plurality of meeting sessions may be different. The meeting category may correspond to at least one of a type of meeting session, a number of attendees in the meeting session, a duration of the meeting session, an average age of the attendees in the meeting session, a topic of the meeting session, an experience of an educator of the meeting session, or content presented in the meeting session. The detected one or more activities performed by each of the plurality of attendees may be associated with at least one of an action performed by an attendee, a gesture performed by the attendee, a head pose of the attendee, a body posture of the attendee, a lip movement of the attendee, a gaze of the attendee, or a facial emotion of the attendee.

The circuitry 202 may be further configured to generate a first three-dimensional (3D) map of the corresponding meeting session including at least one of the plurality of attendees based on the received plurality of images. The circuitry 202 may be further configured to detect one or more activities performed by each of the plurality of attendees during the corresponding meeting sessions over a period of time based on the generated first 3D map.

In accordance with an embodiment, the circuitry 202 may be configured to apply one or more neural network (NN) models (such as one or more NN models 210) on the received plurality of images 114. The circuitry 202 may be further configured to detect one or more activities, performed by each of the plurality of attendees 116, based on the application of one or more NN models 210.

In accordance with an embodiment, the circuitry 202 may be further configured to calculate a focus score for each of the plurality of attendees 116 based on the detected one or more activities related to the corresponding attendee. The circuitry 202 may be further configured to calculate an interaction score for each of the plurality of attendees 116 based on the detected one or more activities related to the corresponding attendee. The circuitry 202 may be further configured to calculate the attention score for each of the plurality of attendees 116 based on the calculated focus score and the calculated interaction score of the corresponding attendee.

In accordance with an embodiment, the circuitry 202 may be configured to determine a facial expression of each of the plurality of attendees 116 based on the received plurality of images 114 and further calculate the attention score for each of the plurality of attendees further 116 based on the determined facial expression, the calculated focus score, and the calculated interaction score of the corresponding attendee.

In accordance with an embodiment, the circuitry 202 may be configured to determine experience information associated with each educator of the corresponding meeting session of the plurality of meeting sessions. The experience information may indicate at least one of an experience, rating, achievements, or feedbacks related to each educator of the corresponding meeting session. The circuitry 202 may be further configured to determine content information associated with content presented during each of the plurality of meeting sessions. The circuitry 202 may be further configured to retrieve profile information related to each of the plurality of attendees 116. The profile information may indicate a preference or an interest for a topic or content associated with the corresponding meeting session. The circuitry 202 may be further configured to determine environment information associated with a geo-location of at least one of an educator of each meeting session or of the plurality of attendees 116. The circuitry 202 may be further configured to calculate the attention score for each of the plurality of attendees 116 further based on the determined facial expression, the determined experience information, the determined content information, the retrieved profile information, the determined environment information, the calculated focus score, and the calculated interaction score of the corresponding attendee.

In accordance with an embodiment, the circuitry 202 may be further configured to apply one or more neural network (NN) models on the received plurality of images. The circuitry 202 may be further configured to detect one or more objects, associated with the plurality of attendees 116, in the received plurality of images 114 based on the application. The circuitry 202 may be further configured to calculate the attention score associated with each of the plurality of attendees 116 based on the detected one or more objects.

In accordance with an embodiment, the circuitry 202 may be configured to determine a first duration of at least one of the one or more activities performed by each of the plurality of attendees 116 during the corresponding meeting sessions and further calculate the attention score for each of the plurality of attendees 116 based on the determined first duration of at least one of the one or more activities.

In accordance with an embodiment, the circuitry 202 may be further configured to generate dashboard information associated with a first attendee 406 of the plurality of attendees 116 based on the calculated attention scores for a set of meeting sessions attended by the first attendee. The generated dashboard may include one or more statistics at least for the set of meeting sessions. The circuitry 202 may be further configured to output the generated dashboard information on a display device.

In accordance with an embodiment of the invention, the circuitry 202 may be configured to determine a position of each of the plurality of attendees 116 in the corresponding meeting session based on the received plurality of images 114 and further train the ML model for each of the plurality of attendees based on the calculated attention score and the determined position of each of the plurality of attendees 116 in the corresponding meeting session.

Exemplary aspects of the disclosure may include a system (such as the system 102 of FIG. 1) that may include a memory (such as the memory 204) that may be configured to store a plurality of machine learning (ML) models (such as the plurality of ML models 106) which may be trained on a plurality of attention scores of a plurality of attendees (such as the plurality of attendees 116) related to a plurality of meeting sessions of different meeting categories. The system 102 may further include circuitry (such as the circuitry 202) that may be configured to receive a first set of images (such as the first set of images 404) of a first attendee (such as the first attendee 406) of the plurality of attendees 116. The first attendee 406 may be related to a first meeting session that may be different from the plurality of meeting sessions. The circuitry 202 may be further configured to detect, over a first period of time, a first set of activities performed by the first attendee 406 during the first meeting session based on the received first set of images 404. The circuitry 202 may be further configured to calculate a first attention score associated with the first attendee 406 for the first period of time based on the detected first set of activities, wherein the first attention score indicates a level of attention of the first attendee 406 in the first meeting session. The circuitry 202 may be further configured to apply a first machine learning (ML) model (such as the first ML model 402) of the plurality of ML models 106 on the calculated first attention score. The circuitry 202 may be further configured to determine a first set of recommendations based on the application of the first ML model 402 on the calculated first attention score and further output the determined first set of recommendations.

In accordance with an embodiment, the determined first set of recommendations include at least one of a first recommendation associated with the first attendee 406 of the plurality of attendees 116, a second recommendation associated with an educator of the first meeting session, or a third recommendation associated with content presented in the first meeting session.

In accordance with an embodiment, the circuitry 202 may be configured to compare the first attention score with a first threshold attention score. The circuitry 202 may be further configured to determine the first set of recommendations based on the comparison. The circuitry 202 may be further configured to generate a notification including at least one of the determined first set of recommendations.

In accordance with an embodiment, the circuitry 202 may be configured to control an audio capture device (such as the audio capture device 108) to capture, during the first meeting session, an interaction (such as the interaction 408) between the first attendee 406 and an educator of the first meeting session. The circuitry 202 may be further configured to determine a second duration of the captured interaction 408. The circuitry 202 may be further configured to determine one or more keywords in the captured interaction 408 based on the captured interaction 408, and further calculate the first attention score associated with the first attendee 406 based on the determined second duration and the determined one or more keywords in the captured interaction 408.

In accordance with an embodiment, the circuitry 202 may be configured to generate a notification for the first attendee 406 or for an educator of the first meeting session based on the application of the first ML model 402 on the calculated first attention score and on a meeting category of the first meeting session. The notification includes at least one of the first set of recommendations.

In accordance with an embodiment, the circuitry 202 may be configured to determine a pattern in the detected first set of activities performed by the first attendee 406. The circuitry 202 may be further configured to detect a malpractice during the first meeting session based on the determined pattern, and further generate a notification for the first attendee 406 or for an educator of the first meeting session based on the detected malpractice.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the particular embodiment disclosed, but that the present disclosure will include all embodiments that fall within the scope of the appended claims.

What is claimed is:

1. A system, comprising:
circuitry configured to:
receive a plurality of images of a plurality of attendees related to a plurality of meeting sessions, wherein a meeting category for one or more meeting sessions of the plurality of meeting sessions is different;
detect, over a period of time, one or more activities performed by each of the plurality of attendees during the corresponding meeting sessions, based on the received plurality of images;
calculate an attention score for each of the plurality of attendees for the corresponding period of time, based on the detected one or more activities related to the corresponding attendee, wherein the attention score indicates a level of attention of each attendee in the corresponding meeting sessions; and
train a machine learning (ML) model for each of the plurality of attendees based on the calculated attention score for each of the plurality of attendees and on the meeting categories of the corresponding meeting sessions.

2. The system according to claim 1, wherein the meeting category corresponds to at least one of a type of meeting session, a number of attendees in the meeting session, a duration of the meeting session, an average age of the attendees in the meeting session, a topic of the meeting session, an experience of an educator of the meeting session, or content presented in the meeting session.

3. The system according to claim 1, wherein the detected one or more activities performed by each of the plurality of attendees are associated with at least one of an action performed by an attendee, a gesture performed by the attendee, a head pose of the attendee, a body posture of the attendee, a lip movement of the attendee, a gaze of the attendee, or a facial emotion of the attendee.

4. The system according to claim 1, wherein the circuitry is further configured to:
generate a first three-dimensional (3D) map of the corresponding meeting session including at least one of the plurality of attendees, based on the received plurality of images; and
detect the one or more activities performed by the plurality of attendees based on the generated first 3D map.

5. The system according to claim 1, wherein the circuitry is further configured to:
calculate a focus score for each of the plurality of attendees based on the detected one or more activities related to the corresponding attendee;
calculate an interaction score for each of the plurality of attendees based on the detected one or more activities related to the corresponding attendee; and
calculate the attention score for each of the plurality of attendees based on the calculated focus score and the calculated interaction score of the corresponding attendee.

6. The system according to claim 5, wherein the circuitry is further configured to:
determine a facial expression of each of the plurality of attendees based on the received plurality of images; and
calculate the attention score for each of the plurality of attendees further based on the determined facial expression, the calculated focus score, and the calculated interaction score of the corresponding attendee.

7. The system according to claim 5, wherein the circuitry is further configured to:
determine experience information associated with each educator of the corresponding meeting session of the plurality of meeting sessions, wherein the experience information indicates at least one of an experience, rating, achievements, or feedbacks related to each educator of the corresponding meeting session;
determine content information associated with content presented during each of the plurality of meeting sessions; and
calculate the attention score for each of the plurality of attendees further based on the determined experience information, the determined content information, the calculated focus score, and the calculated interaction score of the corresponding attendee.

8. The system according to claim 5, wherein the circuitry is further configured to:
retrieve profile information related to each of the plurality of attendees, wherein the profile information indicates a preference or an interest for a topic or content associated with the corresponding meeting session; and
calculate the attention score for each of the plurality of attendees further based on the retrieved profile information, the calculated focus score, and the calculated interaction score of the corresponding attendee.

9. The system according to claim 5, wherein the circuitry is further configured to:
determine environment information associated with a geo-location of at least one of an educator of each meeting session or of the plurality of attendees; and
calculate the attention score for each of the plurality of attendees further based on the determined environment information, the calculated focus score, and the calculated interaction score of the corresponding attendee.

10. The system according to claim 1, wherein the circuitry is further configured to:
apply one or more neural network (NN) models on the received plurality of images;
detect the one or more activities, performed by each of the plurality of attendees, based on the application of the one or more NN models; and
calculate the attention score for each of the plurality of attendees for the period of time based on the detected one or more activities related to the corresponding attendee.

11. The system according to claim 1, wherein the circuitry is further configured to:
apply one or more neural network (NN) models on the received plurality of images;
detect one or more objects, associated with the plurality of attendees, in the received plurality of images based on the application; and
calculate the attention score associated with each of the plurality of attendees based on the detected one or more objects.

12. The system according to claim 1, wherein the circuitry is further configured to:
determine a first duration of at least one of the one or more activities performed by each of the plurality of attendees during the corresponding meeting sessions; and
calculate the attention score for each of the plurality of attendees based on the determined first duration of the at least one of the one or more activities.

13. The system according to claim 1, wherein the circuitry is further configured to:
receive a first set of images of a first attendee of the plurality of attendees, wherein the first attendee is related to a first meeting session different from the plurality of meeting sessions;
detect, over a first period of time, a first set of activities performed by the first attendee during the first meeting session, based on the received first set of images;
calculate a first attention score associated with the first attendee for the first period of time based on the detected first set of activities;
apply a first machine learning (ML) model of a plurality of trained ML models on the calculated first attention score, wherein the first ML model is a trained on a set of historical attention scores associated with the first attendee;
determine a first set of recommendations based on the application of the first ML model on the calculated first attention score; and
output the determined first set of recommendations.

14. The system according to claim 13, wherein the circuitry is further configured to generate a notification for the first attendee or for an educator of the first meeting session based on the application of the first ML model on the calculated first attention score and on a meeting category of the first meeting session, and
wherein the notification includes at least one of the first set of recommendations.

15. The system according to claim 1, wherein the circuitry is further configured to:
generate dashboard information associated with a first attendee of the plurality of attendees based on the calculated attention scores for a set of meeting sessions attended by the first attendee, wherein the generated dashboard includes one or more statistics at least for the set of meeting sessions; and
output the generated dashboard information on a display device.

16. The system according to claim 1, wherein the circuitry is further configured to:
determine a position of each of the plurality of attendees in the corresponding meeting session based on the received plurality of images; and
train the ML model for each of the plurality of attendees based on the calculated attention score and the determined position of each of the plurality of attendees in the corresponding meeting session.

17. A system, comprising:
a memory configured to store a plurality of machine learning (ML) models which are trained on a plurality of attention scores of a plurality of attendees related to a plurality of meeting sessions of different meeting categories; and
circuitry communicably coupled to the memory and configured to:
receive a first set of images of a first attendee of the plurality of attendees, wherein the first attendee is related to a first meeting session different from the plurality of meeting sessions;
detect, over a first period of time, a first set of activities performed by the first attendee during the first meeting session, based on the received first set of images;
calculate a first attention score associated with the first attendee for the first period of time based on the detected first set of activities, wherein the first attention score indicates a level of attention of the first attendee in the first meeting session;
apply a first machine learning (ML) model of the plurality of ML models on the calculated first attention score;
determine a first set of recommendations based on the application of the first ML model on the calculated first attention score; and
output the determined first set of recommendations.

18. The system according to claim 17, wherein the determined first set of recommendations include at least one of a first recommendation associated with the first attendee of the plurality of attendees, a second recommendation associated with an educator of the first meeting session, or a third recommendation associated with content presented in the first meeting session.

19. The system according to claim 17, wherein the circuitry is further configured to:
compare the first attention score with a first threshold attention score;
determine the first set of recommendations based on the comparison; and
generate a notification including at least one of the determined first set of recommendations.

20. The system according to claim 17, wherein the circuitry is further configured to:
control an audio capture device to capture, during the first meeting session, an interaction between the first attendee and an educator of the first meeting session;
determine a second duration of the captured interaction;
determine one or more keywords in the captured interaction based on the captured interaction; and
calculate the first attention score associated with the first attendee further based on the determined second duration and the determined one or more keywords in the captured interaction.

21. The system according to claim 17, wherein the circuitry is further configured to generate a notification for the first attendee or for an educator of the first meeting session based on the application of the first ML model on the calculated first attention score and on a meeting category of the first meeting session, and
wherein the notification includes at least one of the first set of recommendations.

22. The system according to claim 17, wherein the circuitry is further configured to:
determine a pattern in the detected first set of activities performed by the first attendee;
detect a malpractice during the first meeting session based on the determined pattern; and
generate a notification for the first attendee or for an educator of the first meeting session based on the detected malpractice.

23. A method, comprising:
in a system:
receiving a plurality of images of a plurality of attendees related to a plurality of meeting sessions, wherein a meeting category for one or more meeting sessions of the plurality of meeting sessions is different;
detecting, over a period of time, one or more activities performed by each of the plurality of attendees during the corresponding meeting sessions, based on the received plurality of images;
calculating an attention score for each of the plurality of attendees for the corresponding period of time, based on the detected one or more activities related to the corresponding attendee, wherein the attention score indicates a level of attention of each attendee in the corresponding meeting sessions; and
training a machine learning (ML) model for each of the plurality of attendees, based on the calculated attention score for each of the plurality of attendees and on the meeting categories of the corresponding meeting sessions.
